(19) United States
(12) Patent Application Publication
(10) Pub. No.: US 2014/0342053 A1
(43) Pub. Date: Nov. 20, 2014

(54) COMPOSITIONS AND METHODS FOR IMPROVING STABILITY AND EXTENDING SHELF LIFE OF FLAVORING AGENTS

(71) Applicant: SPAI Group Ltd., Grand Cayman (KY)

(72) Inventor: Adel Penhasi, Holon (IL)

(73) Assignee: SPAI Group Ltd., Grand Cayman, KY (US)

(21) Appl. No.: 14/366,710

(22) PCT Filed: Dec. 19, 2012
(86) PCT No.: PCT/IL2012/050533

§ 371 Date: Jun. 19, 2014

Related U.S. Application Data
(60) Provisional application No. 61/577,306, filed on Dec. 19, 2011.

(51) Int. Cl. A23L 1/22

(52) U.S. Cl. CPC A23L 1/22016; A23V 2002/00
USPC 426/96; 426/303

(57) ABSTRACT

The present invention provides for a stabilized oxygen-sensitive flavoring agent particle for admixing to a food product comprising a core composition granule containing at least one oxygen-sensitive flavoring agent and at least one water soluble absorbent; an inner coating layer whose aqueous solution of 0.1% has a surface tension lower than 60 mN/m measured at 25° C.; and an first outer coating layer comprising a polymer having an oxygen transmission rate of less than 1000 cc/m2/24 hr measured at 23° C. and 0% RH, and a water vapor transmission rate of less than 400 g/m2/day.

### FIELD OF THE INVENTION

The present invention is directed generally to food additives and food products, and more particularly, to compositions and methods for improving stability and extending shelf life of flavoring agents.

### BACKGROUND OF THE INVENTION

Flavor is a sensory sensation provided by food and other substances. Although flavor is typically associated with the sense of taste, flavor is also associated with the sense of smell. A flavorant is typically edible chemical substrate which is intended to alter or enhance a food's flavor by changing/enhancing either smell and/or taste.

### SUMMARY

In some demonstrative embodiments there is provided a stabilized oxygen-sensitive flavoring agent particle for admixing to a food product comprising: a core composition granule containing at least one oxygen-sensitive flavoring agent and at least one water soluble absorbent; an inner coating layer whose and an outer coating layer.

According to some embodiments, the stabilized oxygen-sensitive flavoring agent particle for admixing to a food product may comprise a core composition granule containing at least one oxygen-sensitive flavoring agent and at least one water soluble absorbent; an inner coating layer whose aqueous solution of 0.1% has a surface tension lower than 60 mN/m measured at 25° C.; and an outer coating layer comprising a polymer having an oxygen transmission rate of less than 1000 cc/m²/24 hr measured at 23° C. and 0% RH, and a water vapor transmission rate of less than 400 g/m²/day.

In some demonstrative embodiments, the stabilized oxygen-sensitive flavoring agent particle may further comprise a second outer coating layer.

According to some embodiments, the second outer coating layer may have a water vapor transmission rate of less than 300 g/m²/day.

In some demonstrative embodiments, there is provided a stabilized oxygen-sensitive flavoring agent particle for admixing to a food product comprising a core composition in a form of solid powder containing at least one oxygen-sensitive flavoring agent and at least one water soluble absorbent; an inner coating layer, wherein an aqueous solution of 0.1% of the inner coating layer has a surface tension lower than 45 mN/m measured at 25° C.; and an outer coating layer comprising a polymer having an oxygen transmission rate of less than 100 cc/m²/24 hr measured at standard test conditions and a water vapor transmission rate of less than 400 g/m²/day.

According to some embodiments, the stabilized oxygen-sensitive flavoring agent particle may comprise a second outer coating layer, e.g., to provide protection against water and/or humidity penetration.

According to some embodiments, the second outer coating layer may have a water vapor transmission rate of less than 300 g/m²/day.

According to some demonstrative embodiments, there is provided a method of producing a stabilized, multi-layered particle containing oxygen-sensitive flavoring agent, comprising preparing a suspension of oxygen-sensitive flavoring agents using at least one surfactant and at least one hydrophilic water soluble polymer; spraying the resulting suspension onto at least one water soluble absorbent to obtain a core granule; coating the core granule with an inner coating layer comprising at least one water soluble polymer whose aqueous solution of 0.1% of the inner coating layer has a surface tension lower than 45 mN/m measured at 25° C. for preventing penetration of water into said core granule and for adjusting surface tension, to obtain a water-sealed coated particle having an adjusted surface tension; and coating said water-sealed coated particle having an adjusted surface tension with an outer coating layer that reduces transmission of oxygen and humidity into the core granule to obtain a multi-layered particle containing oxygen-sensitive flavoring agent.

In some demonstrative embodiments, the multi-layered particle containing oxygen-sensitive flavoring agent may be coated with a second outer coating layer comprising a polymer having a water vapor transmission rate of less than 400 g/m²/day, preferably, less than 350 g/m²/day, more preferably, less than 300 g/m²/day, and providing further protection against water/humidity penetration.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 shows an example flow diagram for some embodiments of the present invention;

FIG. 2 provides a schema of a multiple-layered microencapsulated an oxygen-sensitive flavoring agent according to an embodiment of the present invention;

FIG. 3 provides a schema of a multiple-layered microencapsulated an oxygen-sensitive flavoring agent according to some embodiments of the present invention;

FIG. 4 provides an example schema of a contact angle (θ) formed when a liquid does not completely spread on a substrate;

FIG. 5 provides an example illustration of the effect of capillarity for the flow of a penetrant through void or pore on the surface of a solid; and

FIG. 6 shows an example schema of a capillary rise (height) (hc) of a penetrant through a void or pore.

FIG. 7 provides exemplary oxidation test results for some embodiments of the present invention.

FIG. 8 provides exemplary oxidation test results for some embodiments of the present invention.

FIG. 9 provides exemplary oxidation test results for some embodiments of the present invention.

### DETAILED DESCRIPTION OF THE INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components and/or units have not been described in detail so as not to obscure the discussion.

According to some demonstrative embodiments, the present invention provides for compositions and methods for improving stability and/or extending the shelf life of flavoring agents (also referred to herein as “FLAVORCAPS”).

According to some demonstrative embodiments, the compositions and methods disclosed herein may impart, enable, facilitate and/or provide a variety of benefits to flavoring agents and the food in which the FLAVORCAPS have been added.

As discussed herein, in some demonstrative embodiments, the present invention is directed generally to food additives and food products and more particularly, to compositions and methods for improving stability and extending shelf life of flavoring agents.

One aspect of FLAVORCAPS is stabilization of “flavoring” or “flavorant” or “flavoring agent” which commonly denotes the combined chemical sensations of taste and smell. Some implementations of FLAVORCAPS may also relate to the fragrance oil, essential oil and aroma compounds which refer to edible chemicals and extracts that alter the flavor of food and food products through the sense of smell.

The term “flavoring agent” as used herein, may refer to any suitable smell flavorant, fragrance oil, essential oil, aroma compounds and the like.

According to some embodiments, the flavoring agents which are stabilized according to some implementations of the present invention may be either solid or liquid, including, e.g., liquid forms such as oil, or a solution of oil in a solvent.

In some demonstrative embodiments of the present invention there are provided formulations and methods of preparation for a stabilized flavoring agent composition, e.g., a fast dissolving composition for fast delivery of flavoring agents after use.

According to some demonstrative embodiments, the flavoring agents may be efficiently stabilized for use in a food preparation process by a unique combination of coating layers, e.g., having a specified arrangement order.

According to some embodiments, the flavoring agents may be formulated in a core or a granule coated with one or more coating layers, thereby obtaining flavoring agent compositions providing stable flavoring agents, e.g., even after a prolonged time of storage at ambient temperature in the presence of oxygen and humidity.

In some embodiments, the present invention also provides for further stabilization of such flavoring agents, on storage and shelf life, in the food stuff into which the protected flavoring agents have been added. In some embodiments, FLAVORCAPS may provide solid granular/particular flavoring agents as food additives. According to these embodiments, the flavoring agents may be dissolved quickly after use, e.g., for fast delivery of a flavor altering effect.

Flavoring agents may be sensitive to oxygen (i.e., they are oxidizable). Such flavoring agents may range from oil products, solid flavorants, herbal extracted products, processed compounds, volatile liquid compounds, synthetic or natural compounds, synthetic aroma compounds or natural essential oils that are diluted with a carrier like propylene glycol, vegetable oil, or mineral oil and the like. Degradation (such as oxidation) of flavoring agents (e.g., oxygen-sensitive flavoring agents) may cause a decline in their functionality and over time may result in a deficiency in taste and/or smell properties associated with the agents. In some cases, the oxidation process of such oxidizable agents may be accompanied with unpleasant taste and pungent odor. Oxidation is a kinetic process that can be enhanced by increasing temperature. The stability of oxygen-sensitive flavoring agents may be enhanced at either ambient temperature or higher temperatures, but this may eventually shorten the shelf life of such agents. The shortened shelf life may prevent such oxygen-sensitive flavoring agents from being added to foods that undergo a heating process during handling and preparation. Furthermore, encapsulation of liquid heat sensitive components (for example, liquid components into matrices that are edible) is generally difficult.

In some demonstrative embodiments, there is provided a composition and/or process for the preparation of protected flavoring agents, e.g., protected against oxygen and humidity (water vapor). In some embodiments, the protected flavoring agents may be incorporated into foodstuffs, engineered foods and functional foods such as creams, biscuits creams, biscuit filling, chocolates, sauces, mayonnaise, cereals, baked goods, pastry goods, cheeses, dairy products such as yogurts and the like, liquid-based foodstuffs such as beverages, flavored water, flavored sparkling water and the like.

According to some demonstrative embodiments, the stabilized oxygen-sensitive flavoring agent granules that are added to food products may be fast dissolved after consumption to release the flavoring agents into the oral cavity, and accordingly alter taste and smell. In some embodiments, the composition of the present invention may include a stabilized oxygen-sensitive flavoring agent granule(s) as food additive(s), to be added, e.g., into a food product, comprising: (a) a fast dissolving core composition in the form of solid powder or granulate containing one or more oxygen-sensitive flavoring agents and at least one water soluble absorbent compound; a stabilizer; and optionally, one or more other food-grade ingredients, making the total amount of the one or more oxygen-sensitive flavoring agents in the core composition mixture between about 10% and 90% by weight of the core composition; (b) a first coating layer which is the most inner coating layer comprising at least one water soluble polymer wherein the first coating layer aqueous solution of 0.1% has a surface tension lower than 60 mN/m, preferably, lower than 50 mN/m, more preferably, lower than 45 mN/m, measured at 25° C.; (c) an outer coating layer comprising a water soluble polymer having an oxygen transmission rate of less than 1000 cc/m²/24 hr, preferably, less than 500 cc/m²/24 hr, more preferably, less than 100 cc/m²/24 hr, measured at standard test conditions (i.e. 73° F./23° C.) and 0% RH.

According to some demonstrative embodiments, the composition of the present invention may optionally include a second outer layer (also referred to herein as the “outermost layer”) comprising a water soluble polymer having a water vapor transmission rate of less than 400 g/m²/day, preferably, less than 350 g/m²/day, more preferably, less than 300 g/m²/day.

In some demonstrative embodiments of the present invention there is provided a process and/or method for stabilizing oxygen-sensitive flavoring agents, comprising: (a) preparing an emulsion of one or more oxygen-sensitive flavoring agents by dispersing the one or more oxygen-sensitive flavoring agents and an oxygen scavenger in water, e.g., purified water or degassed water, using an emulsifier and/or a homogenizer. The emulsion may further include a hydrophilic water soluble polymer, e.g., to enhance the absorption and adhesion of the flavoring agents into the pores of a porous water soluble absorbent and preventing the destruction of the water soluble absorbent; (b) spraying the emulsion onto a water soluble absorbent, e.g., a porous water soluble absorbent. According to some embodiments, the spraying may be done under an inert gas to obtain a solid core comprising the one or more oxygen-sensitive flavoring agents absorbed by an absorbent (e.g., solidified oil). According to some embodiments, the water soluble absorbent may be preheated at 40° C. prior to spraying the emulsion; (c) coating the resulting solid core with: (i) a first coating layer comprising at least one water soluble polymer whose aqueous solution of 0.1% has a surface tension lower than 60 mN/m, preferably, lower than 50 mN/m, more preferably, lower than 45 mN/m, measured at 25° C. According to some embodiments, applying the first coating layer onto the solid core may result in forming a stable film around the core to obtain a solid-coated core; (d) coating the solid-coated core with an outer coating layer comprising a water soluble polymer having an oxygen transmission rate of less than 1000 cc/m²/24 hr, preferably, less than 500 cc/m²/24 hr, more preferably, less than 100 cc/m²/24 hr, measured in standard test conditions (i.e. 73° F./23° C. and 0% RH), and a water vapor transmission rate of less than 400 g/m²/day, preferably, less than 350 g/m²/day, more preferably less than 300 g/m²/day, to obtain stabilized oxygen-sensitive flavoring agents (micro-particles). According to some demonstrative embodiments, the process and/or method for stabilizing oxygen-sensitive flavoring agents of the present invention may optionally include applying a second outer layer (also referred to herein as the “outermost layer”) comprising a water soluble polymer having a water vapor transmission rate of less than 400 g/m²/day, preferably, less than 350 g/m²/day, more preferably, less than 300 g/m²/day.

In some demonstrative embodiments of the present invention, there is provided a process and/or method for stabilizing oxygen-sensitive flavoring agents, comprising: (a) preparing a solution of one or more oxygen-sensitive flavoring agents and a stabilizer, in a solvent; (b) spraying the solution onto a water soluble substrate while using an inert gas and/or under a non-reactive atmosphere to obtain a solid core comprising the one or more oxygen-sensitive flavoring agents absorbed by absorbent (e.g., solidified oil); (c) coating the solid core with a first coating layer comprising at least one water soluble polymer whose aqueous solution of 0.1% has a surface tension lower than 60 mN/m, preferably lower than 50 mN/m, more preferably, lower than 45 mN/m, measured at 25° C., to form a stable film around the core to obtain a solid-coated core; (d) coating the solid-coated core with an outer coating layer comprising a water soluble polymer having an oxygen transmission rate of less than 1000 cc/m²/24 hr, preferably, less than 500 cc/m²/24 hr, more preferably, less than 100 cc/m²/24 hr measured in standard test conditions (i.e. 73° F./23° C. and 0% RH), and a water vapor transmission rate of less than 400 g/m²/day, preferably, less than 350 g/m²/day, more preferably, less than 300 g/m²/day, to obtain stabilized oxygen-sensitive flavoring agents (micro-particles).

According to some demonstrative embodiments, the process and/or method for stabilizing oxygen-sensitive flavoring agents of the present invention may optionally include applying a second outer layer (“an outermost layer”) comprising a water soluble polymer having a water vapor transmission rate of less than 400 g/m²/day, preferably, less than 350 g/m²/day, more preferably, less than 300 g/m²/day.

In some embodiments, the stabilized oxygen-sensitive flavoring agent microcapsules may have a fast dissolving core comprising oxygen-sensitive flavoring agents absorbed by an water soluble absorbent such as sorbitol and/or the like, a stabilizer such as an oxygen scavenger containing a L-cysteine base or hydrochloride, vitamin E, tocopherol, polyphenols, etc., a hydrophilic water soluble polymer, where the total amount of oxygen-sensitive flavoring agents in the mixture is between about 10% and about 90% by weight of the core composition, a first coating layer, which is the most inner coating layer, comprising at least one water soluble polymer whose aqueous solution of 0.1% has a surface tension lower than 60 mN/m, preferably, lower than 50 mN/m, more preferably, lower than 45 mN/m, measured at 25° C., forming a stable film around the core containing the oxygen-sensitive flavoring agents to obtain a solid-coated core; an outer coating layer comprising a water soluble polymer having oxygen transmission rate of less than 1000 cc/m²/24 hr, preferably, less than 500 cc/m²/24 hr, more preferably, less than 100 cc/m²/24 hr measured at standard test conditions (i.e. 73° F./23° C. and 0% RH), to obtain stabilized oxygen-sensitive flavoring agents (micro-particles); and, optionally, (e) a second outer (“outermost layer”) comprising a water soluble polymer having a water vapor transmission rate of less than 400 g/m²/day, preferably, less than 350 g/m²/day, more preferably, less than 300 g/m²/day.

According to some demonstrative embodiments there is provided a process comprises (a) preparation of a fast dissolving core composition in form of solid powder or granulate containing oxygen-sensitive flavoring agents and at least one water soluble absorbent, a stabilizer, and optionally other food grade ingredients, where the total amount of oxygen-sensitive flavoring agents in the mixture is from about 10% to about 90% by weight of the core composition by either emulsion or suspension of oxygen-sensitive flavoring agents in water using food acceptable surfactant, and/or surface active agent, and/or emulsifying agent and/or dispersing agent, and/or wetting agent or solution of oxygen-sensitive flavoring agents in a food acceptable organic solvent and (b) coating said core or granules with (i) a first coating layer which may be the most inner coating layer comprising at least one water soluble polymer whose aqueous solution of 0.1% has a surface tension lower than 60 mN/m, preferably, lower than 50 mN/m, more preferably, lower than 45 mN/m, measured at 25° C., for binding the outer layer to the fast dissolving core; (ii) an outer coating layer comprising a water soluble polymer having oxygen transmission rate of less than 1000 cc/m²/24 hr, preferably, less than 500 cc/m²/24 hr, more preferably, less than 100 cc/m²/24 hr, measured at standard test conditions (i.e. 73° F./23° C. and 0% RH), for providing the oxygen-sensitive flavoring agents with oxygen resistance; and optionally (iii) a second outer coating layer (“outermost layer”) comprising a water soluble polymer having a water vapor transmission rate of less than 400 g/m²/day, preferably, less than 350 g/m²/day, more preferably, less than 300 g/m²/day for providing the oxygen-sensitive flavoring agents with humidity resistance.

According to some demonstrative embodiments, the process as described herein may include: (a) preparation of a fast dissolving core composition in form of solid powder or granulate containing oxygen-sensitive flavoring agents and at least one water soluble absorbent, a stabilizer and optionally other food grade ingredients, wherein the total amount of oxygen-sensitive flavoring agents in the mixture is from about 10% to about 90% by weight of the core composition by either emulsion or suspension of oxygen-sensitive flavoring agents in water using food acceptable surfactant, and/or surface active agent, and/or emulsifying agent and/or dispersing agent, and/or wetting agent and/or a hydrophilic water soluble polymer enhancing the absorption and adhesion of the flavoring agents into the pores of a porous water soluble absorbent and preventing the destruction of the water soluble absorbent that may occur by the emulsion or suspension or solution of oxygen-sensitive flavoring agents in a food acceptable organic solvent and (b) coating said core or granules with (i) a first coating layer which is the most inner coating layer comprising at least one water soluble polymer whose aqueous solution of 0.1% has a surface tension lower than 60 mN/m, preferably, lower than 50 mN/m, more preferably, lower than 45 mN/m, measured at 25° C., for binding the outer layer to the fast dissolving core; and (ii) an outer coating layer comprising a water soluble polymer having oxygen transmission rate of less than 1000 cc/m²/24 hr, preferably, less than 500 cc/m²/24 hr, more preferably, less than 100 cc/m²/24 hr, measured at standard test conditions (i.e. 73° F./23° C. and 0% RH), for providing the oxygen-sensitive flavoring agents with oxygen resistance and, in some embodiments, optionally at least one plasticizer. In some embodiments, the process may optionally further comprise coating said core or granules with (iii) a second outer coating layer (“outermost layer”) comprising a water soluble polymer having a water vapor transmission rate of less than 400 g/m²/day, preferably less than 350 g/m²/day, more preferably, less than 300 g/m²/day for providing the oxygen-sensitive flavoring agents with humidity resistance.

According to some demonstrative embodiments there is provided a method for the preparation of oxygen and humidity resisting oxygen-sensitive flavoring agents. According to some embodiments, a composition produced according to the method provided herein may possess high stability and prolonged shelf life, e.g., at ambient temperatures. In some embodiments, the method comprises preparing granular or particular oxygen-sensitive flavoring agents having: (a) a fast dissolving core composition in form of solid powder or granulate containing one or more oxygen-flavoring agents and at least one porous water soluble absorbent compound, a stabilizer and in further embodiments other food grade ingredients such a binder, including for example, a hydrophilic water soluble polymer to enhance the absorption and adhesion of the flavoring agents into the pores of the water soluble absorbent and/or to prevent the destruction of the water soluble absorbent (which may occur by the emulsion); a surfactant and/or an anti-glidant. In some demonstrative embodiments, the total amount of oxygen-sensitive flavoring agents in the mixture is from about 10% to about 90% by weight of the core composition; (b) a first coating layer whose aqueous solution of 0.1% has a surface tension lower than 60 mN/m, preferably, lower than 50 mN/m, more preferably, lower than 45 mN/m, measured at 25° C.; and (c) a second coating layer comprising a polymer having oxygen transmission rate of less than 1000 cc/m²/24 hr, preferably, less than 500 cc/m²/24 hr, more preferably, less than 100 cc/m²/24 hr, measured at standard test conditions (i.e., 73° F./23° C. and 0% RH), and a water vapor transmission rate of less than 400 g/m²/day, preferably, less than 350 g/m²/day, preferably less than 300 g/m²/day, and in some further embodiments at least one plasticizer. According to some demonstrative embodiments, the second coating layer can chemically be either similar to or different from said first coating layer. In some demonstrative embodiments, the method may optionally include applying an outermost coating layer comprising a water soluble polymer having a water vapor transmission rate of less than 400 g/m²/day, preferably, less than 350 g/m²/day, more preferably, less than 300 g/m²/day, and/or a plasticizer.

In some demonstrative embodiments, said one or more oxygen-sensitive flavoring agents may comprise at least one flavor compound, smell flavorant, essential oil, aroma compound, fragrance oil or the like. Non limiting examples of flavorants are explained in detail below.

According to some demonstrative embodiments, the stabilized oxygen-sensitive flavoring agents core granule or core mixing may be a coated particle(s), comprising at least three layered phases, such as, by way of non-limiting example, a core and three coats, or a core and three or more coats. In some embodiments, one of the coats is an inner coat comprising a hydrophilic polymer which is also soluble in an organic solvent. According to some embodiments, the inner coat may contribute mainly to prevention of water or humidity penetration into the core during the coating of the outer layer or during later stages and may be responsible for providing binding and adhesion of the outer coat to the core, wherein said inner coat may further provide oxygen and/or humidity resistance to the core. In some embodiments, a second coat is an outer coat which may be responsible for preventing transmission of humidity and oxygen into the core during the storage and shelf life. According to some embodiments, there is an outermost coating layer which may comprise a water soluble polymer providing further humidity resistance. According to some embodiments, it may be one of the layers that contributes maximally to said oxygen resistance and water and/or humidity penetration into the core; however, according to other embodiments of the present invention, the stabilized oxygen-sensitive flavoring agents granule may comprise two or more layers that contribute to the process stability of the oxygen-sensitive flavoring agents, as well as to the stability during storing of said food and during safe delivery of the oxygen-sensitive flavoring agents in the oral cavity. Likewise, in some embodiments, the two inner and outermost coats may be chemically the same polymers with either same or different viscosities and/or molecular weights.

In some demonstrative embodiments, the core may comprise at least one water soluble absorbent or substrate which may be responsible for absorbing the oxygen-sensitive flavoring agents by capillary action/capillary force or being coated by a mixture comprises oxygen-sensitive flavoring agents and a water soluble polymer as a binder enhancing the absorption and adhesion of the flavoring agents into the water soluble absorbent pores and preventing the destruction of the water soluble absorbent which may occur where either an emulsion or suspension of the oxygen-sensitive flavoring agents is used.

According to some demonstrative embodiments of the present invention, there is provided a process of manufacturing food, comprising: i) providing to said food one or more oxygen-sensitive flavoring agents; at least one water soluble absorbent which absorbs the oxygen-sensitive flavoring agents by capillary force and optionally other excipients, including, for example, at least one stabilizer (oxygen scavenger), a binder comprising at least one water soluble polymer, a surfactant (surface free energy-lowering agent), using an emulsion or suspension of the oxygen-sensitive flavoring agents or a solution of oxygen-sensitive flavoring agents with an organic solvent thereby obtaining a core; ii) coating particles of said core with an outer water soluble polymer layer. According to some embodiments, the outer polymer layer confers stability to said oxygen-sensitive flavoring agents, for example, upon storage, and/or extending shelf life of the food at ambient temperatures under the conditions of oxygen and humidity. In some embodiments, the outer layer may also contain other excipients such as, by way of non-limiting example, at least one plasticizer and at least one surface free energy-lowering agents, thereby obtaining particles coated with one layer.

According to some demonstrative embodiments, the coating layers described herein may include a combination of additional excipients such as, by way of non-limiting example, at least one plasticizer, e.g., polyethylene glycol (PEG) 400 and/or triacetin, at least one water soluble absorbent e.g., sorbitol, a stabilizer, e.g., L-cysteine base or tocopherol, a surfactant, e.g., tween 80, a binder, e.g., hydroxypropylmethylcelluloses (HPMC) According to some embodiments, the inner coating layer may comprise hydroxypropyl cellulose (HPC), and the outer coating layer may comprise carboxymethylcellulose (CMC) 7LF and/or carboxymethylcellulose (CMC) 7L2P.

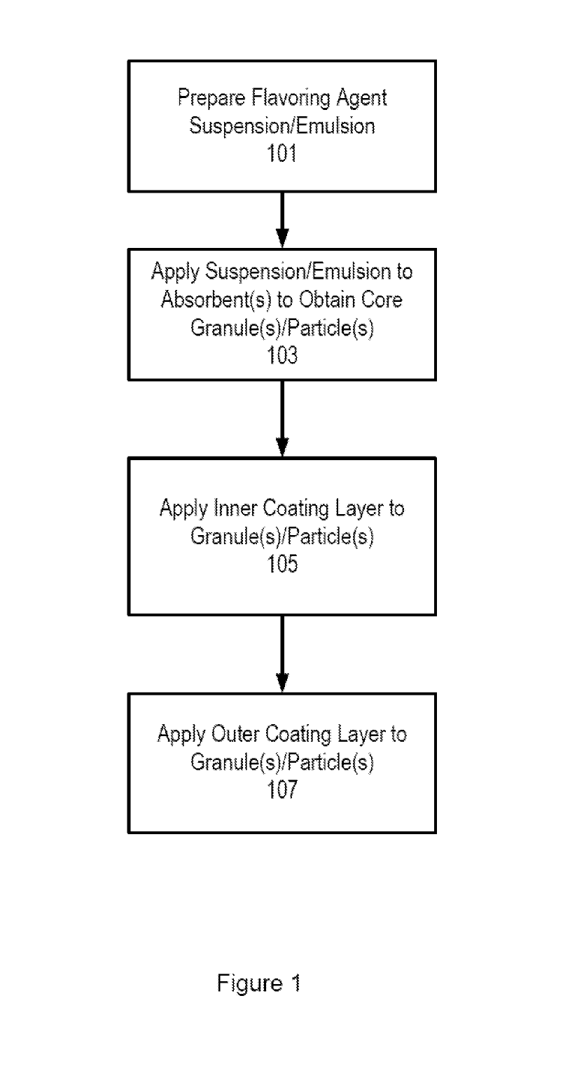

As illustrated in FIG. 1, according to some embodiments of the present invention, the process of manufacturing micro encapsulated oxygen-sensitive flavoring agents may comprise: preparing a suspension/emulsion of oxygen-sensitive flavoring agent(s) in water using an appropriate surfactant and a water soluble polymer (101); spraying the resulting emulsion/suspension onto at least one water soluble absorbent thereby obtaining a core granule or particle (103); coating particles of said core granule with an inner coating layer (105) comprising a water soluble polymer for preventing or reducing the penetration of water or humidity into said core to obtain water-sealed coated particles; and for adjusting surface tension for further coating with an outer coating layer thereby obtaining water-sealed coated particles having an adjusted surface tension; and

coating said water-sealed coated particles having an adjusted surface tension with an outer coating layer (107) for reducing transmission of oxygen and humidity into the core to obtain a multiple-layered particle containing oxygen-sensitive flavoring agents showing superior stability against oxygen and humidity on storage duration and during the shelf life and thus showing higher vitality.

According to some demonstrative embodiments, there is provided a composition of at least one oxygen-sensitive flavoring agent comprising the stabilized granular or particular oxygen-sensitive flavoring agent described herein exhibiting high humidity-resistance and oxygen-resistance at ambient temperature and long storage stability.

According to some demonstrative embodiments, there is provided a composition of at least one oxygen-sensitive flavoring agent comprising the stabilized granular or particular oxygen-sensitive flavoring agent described above exhibiting high humidity-resistance and oxygen-resistance at ambient temperature and long storage stability and fast dissolution capability.

In some demonstrative embodiments, there is provided a process for manufacturing microencapsulated oxygen-sensitive flavoring agents. The process comprises: mixing oxygen-sensitive flavoring agents with at least one water soluble absorbent to obtain a core granule or particle; coating particles of said core granule with an inner coating layer comprising a water soluble polymer which prevents or reduces the penetration of water or humidity into said core and may further adjust surface tension, for example, for further coating with an outer coating layer; and coating said water-sealed coated particles having an adjusted surface tension with an outer coating layer for reducing transmission of oxygen and humidity into the core thereby obtaining a multiple-layered particle containing oxygen-sensitive flavoring agents showing superior stability against oxygen and humidity on storage duration and during the shelf life i.e., showing higher vitality.

In some embodiments, when the one or more oxygen-sensitive flavoring agents are mixed with at least one absorbent, the oxygen-sensitive flavoring agents may be absorbed by the absorbent via a capillary force action exerted by a porous structure of said absorbent.

For example, a composition according to the present invention may include a core comprising the one or more oxygen-sensitive flavoring agents mixed with at least one absorbent such as sorbitol, a stabilizer such as L-cysteine base or tocopherol, a surfactant such as tween 80, a binder such as hydroxypropylmethylcelluloses (HPMC); and coated with an inner coating layer such as hydroxypropylcellulose (HPC), an outer coating layer such as carboxymethylcellulose (CMC) 7LF and/or carboxymethylcellulose (CMC) 7L2P, and a plasticizer such as polyethylene glycol (PEG) 400 and/or triacetin.

In some embodiments, the process of manufacturing micro encapsulated oxygen-sensitive flavoring agents comprises: preparing a solution of oxygen-sensitive flavoring agents in an organic solvent to obtain a solution; spraying the resulting solution onto at least one absorbent to obtain a core granule or particle; coating particles of said core granule with an inner coating layer comprising a water soluble polymer for preventing or reducing the penetration of water or humidity into said core to obtain water-sealed coated particles; and for adjusting surface tension for further coating with an outer coating layer to obtain water-sealed coated particles having an adjusted surface tension; and coating said water-sealed coated particles having an adjusted surface tension with an outer coating layer for reducing transmission of oxygen and humidity into the core to obtain a multiple-layered particle containing oxygen-sensitive flavoring agents showing superior stability against oxygen and humidity on storage duration and during the shelf life thus showing higher vitality.

In some demonstrative embodiments, the food products referred to herein, e.g., food products containing the oxygen-sensitive flavoring agents which are prepared according to some embodiments of the present invention, may be exposed to ambient temperatures below 100° C., in some embodiments below 80° C., in some embodiments below 60° C., during production process or preparation process and or storage.

According to some demonstrative embodiments, the method and/or process of the present invention may provide for the preparation of food products containing oxygen-sensitive flavoring agents, such as oxygen-sensitive flavoring agents in creams, biscuits creams, biscuit fill-in, chocolates, sauces, mayonnaise, cereals, baked goods, pastry goods, cheeses, dairy products such as yogurts and the like, liquid-based foodstuffs such as beverages, flavored water, flavored sparkling water and the like. In some embodiments, a mixture that comprises oxygen-sensitive flavoring agents material may be prepared and/or then converted to granules, e.g., by fluidized bed technology, such as by way of non-limiting example: Glatt or turbo jet, Glatt or an Innojet coater/granulator, a Huttlin coater/granulator, a Granulex, and/or the like. The resulting granules may be encapsulated by a first layer, for example, a water soluble polymer layer having relatively low surface tension for adjusting the surface tension for further coating and/or for resisting oxygen, water or humidity penetration into the core granule which may occur in further steps preparation, and then coating with a polymer which has relatively low oxygen and water vapor transmission rate for sealing said granular or particular oxygen-sensitive flavoring agents against oxygen and humidity.

According to some embodiments, the resulting micro-encapsulated oxygen-sensitive flavoring agents according to the above may be introduced to a food product which may also undergo a heating step during its preparation process. Alternatively, the resulting microencapsulated oxygen-sensitive flavoring agents discussed herein may be added to a food product which may not undergo a heating step during its preparation process.

In some embodiments, during exposure of the above-described microencapsulated oxygen-sensitive flavoring agents to oxygen and humidity, such as during the preparation process of the food product, the outer layer, which is composed of a humidity and oxygen resistance-providing polymer, or the outer layer together with the outermost layer which is an optional coating layer, may form a sealing barrier surrounding the oxygen-sensitive flavoring agents core granule, preventing transmission of humidity and oxygen to the oxygen-sensitive flavoring agents.

After placing a food product containing the encapsulated particular oxygen-sensitive flavoring agents, prepared as described above, in storage or on shelf at ambient temperature, the oxygen-sensitive flavoring agents protected according to some embodiments described herein, may show higher stability and viability during the storage, thus providing longer shelf life. FLAVORCAPS may thus provide a food product containing oxygen-sensitive flavoring agents which are stable flavoring agents which are stable throughout a heating step needed during the preparation of the product for human uses, for example, as described in detail above.

Such a food product will have a higher stability and viability of oxygen-sensitive flavoring agents, and thus show a prolonged shelf life. In some embodiments, such a food product may comprise: (a) encapsulated granules, made of a mixture that comprises oxygen-sensitive flavoring agents which is dried and converted to core granules to be encapsulated by a first layer, a second layer and a third layer. According to some embodiments, the first layer may comprise at least one polymer having relatively a low surface tension, for example, for adjusting the surface tension of the core particle for further coating by a second coating and/or for resisting oxygen, water and humidity penetration into the core granules. The second layer may comprise at least one polymer capable of resisting transition of oxygen and humidity into the core, and optionally a third layer which may comprise at least one water soluble polymer capable of resisting transition of humidity into the core; and (b) a food product and/or food product base to which the micro-encapsulated granules may be added. According to some embodiments, the resulting food product may contain high viability and stability of oxygen-sensitive flavoring agents even after long duration of storage at ambient temperature and thus may show a prolonged shelf life.

According to some embodiments, the process of the present invention may include preparing the core or granule(s) using dried solidified oxygen-sensitive liquid flavoring agents. These granules may then be encapsulated by one or more coating layers, including for example, an inner layer, e.g., to resist the oxygen, water and humidity penetration into the granules; a second layer, e.g., for preventing oxygen and humidity transmission to the oxygen-sensitive flavoring agents core/granules. According to some embodiments, the encapsulated granular/particular oxygen-sensitive flavoring agents may then be added to a food product, for example, right before the final preparation. The food product containing the encapsulated granular/particular oxygen-sensitive flavoring agents may contain high stability/vitality oxygen-sensitive flavoring agents even after long duration of storage at ambient temperature and thus may show a prolonged shelf life.

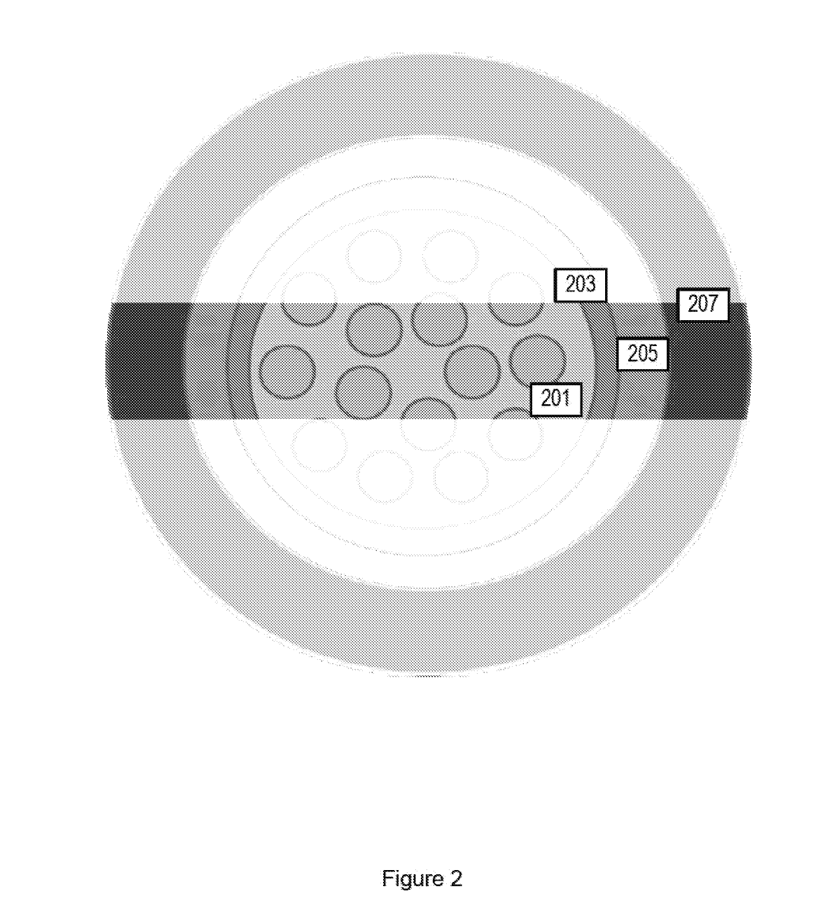

FIG. 2 illustrates a multiple-layered microencapsulated oxygen-sensitive flavoring agent such as fragrance oil or essential oil according to some embodiments of the present invention. The inner core 201 comprises a porous absorbent saturated by an oxygen-sensitive flavoring agent. A first coating layer 203 which is the most inner coating layer comprises a water soluble polymer whose aqueous solution of 0.1% has a surface tension lower than 60 mN/m. The outer layer 205 comprises a polymer having oxygen transmission rate of less than 1000 cc/m²/24 hr. The outermost layer 207 which is an optional coating layer comprises a water soluble polymer having a water vapor transmission rate of less than 400 g/m²/day.

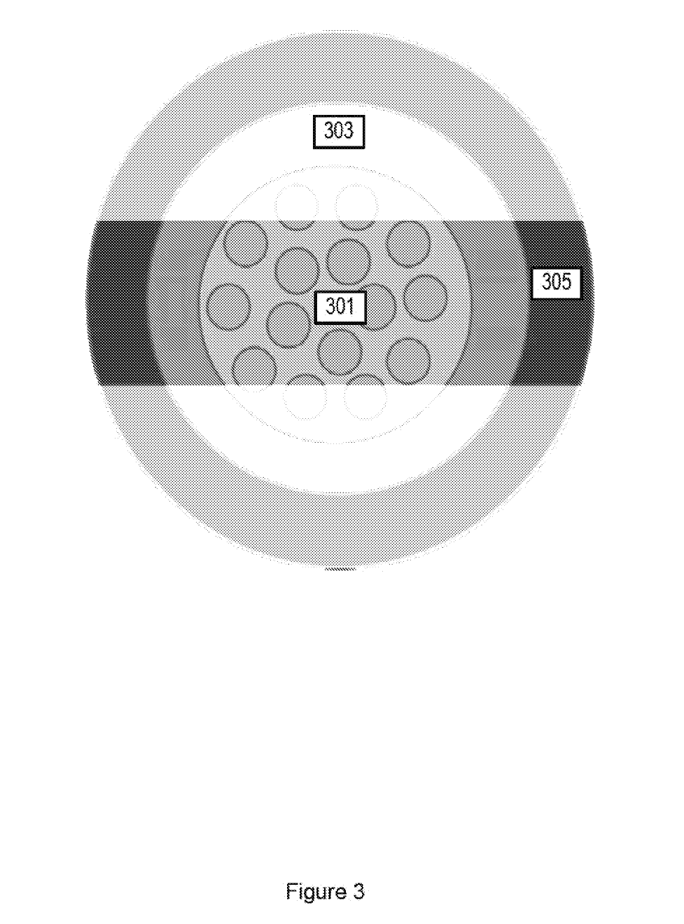

FIG. 3 illustrates a multiple-layered microencapsulated oxygen-sensitive flavoring agent such as fragrance oil or essential oil according to some embodiments of the present invention. An inner core 301 comprises a porous absorbent saturated by oxygen-sensitive flavoring agent and coated by a first coating layer 303 comprising at least one water soluble polymer whose aqueous solution of 0.1% has a surface tension lower than 60 mN/m. The next outer and/or outermost layer 305 comprises a polymer having oxygen transmission rate of less than 1000 cc/m²/24 hr and a water vapor transmission rate of less than 400 g/m²/day.

Oxygen-Sensitive Flavoring Agents-Containing Core or Granules

According to some embodiments, oxygen-sensitive flavoring agents in said inner core or granules may be absorbed by a water soluble absorbent or absorbents. Depending on the implementation, the core may optionally contain other food grade additives, such as, by way of non-limiting example, stabilizers, binders, surfactant, antioxidant, and/or the like. Examples of oxygen-sensitive flavoring agents include but are not limited to flavor compound, smell flavorant, essential oil, aroma compound, fragrance oil or the like.

Absorbent

According to some embodiments, oxygen-sensitive flavoring agents in a granule core may be absorbed by an absorbent via capillary force action resulting from the porous structure of the absorbent. In some implementations, the higher the capillary force, the more effective the absorbance. As discussed herein, capillarity or capillary action is a phenomenon in which the surface of a liquid is observed to be elevated or depressed where it comes into contact with a solid.

Capillarity is spontaneous movement of liquids up or down narrow tubes, or pores existing in the surface of a solid as a part of its surface texture. As discussed herein, capillary action is a physical effect caused by the interactions of a liquid with the walls of a thin tube or pores existing in the surface of a solid, and the capillary effect is a function of the ability of the liquid to wet a particular material.

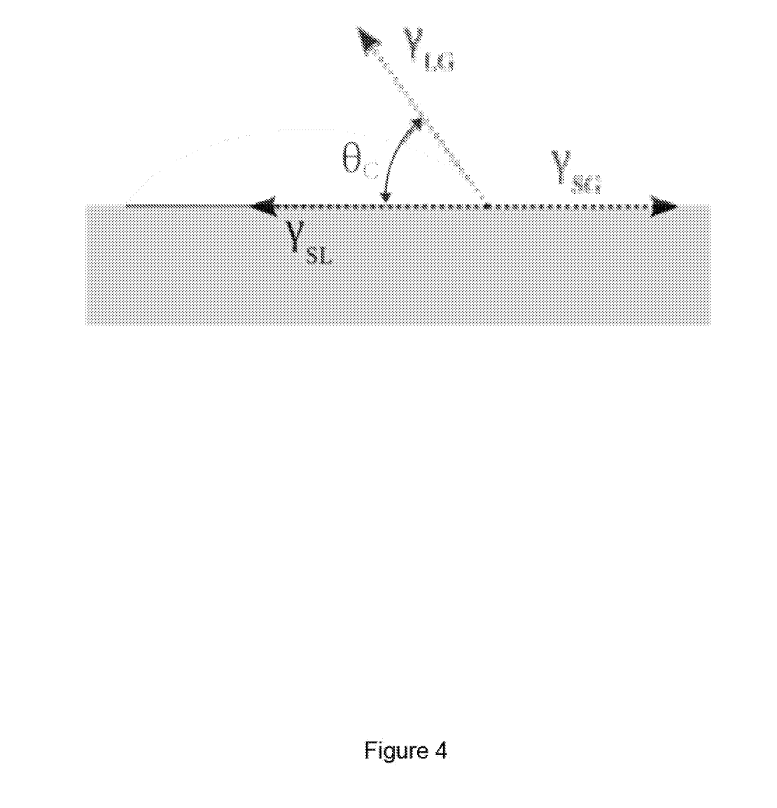

As discussed herein with respect to some embodiments of the present invention, an important characteristic of a liquid penetrant material is its ability to freely wet the surface of a target object. At the liquid-solid surface interface, if the molecules of the liquid have a stronger attraction to the molecules of the solid surface than to each other (i.e., the adhesive forces are stronger than the cohesive forces), wetting of the surface occurs. Alternately, if the liquid molecules are more strongly attracted to each other than the molecules of the solid surface (i.e., the cohesive forces are stronger than the adhesive forces), the liquid beads-up and does not wet the surface. One way to quantify a liquid's surface wetting characteristics is to measure the contact angle of a drop of liquid placed on the surface of an object. The contact angle is the angle formed by the solid/liquid interface and the liquid/vapor interface measured from the side of the liquid (e.g., as illustrated in FIG. 4). Liquids wet surfaces when the contact angle is less than 90 degrees. For a penetrant material to be effective, the contact angle should be as small as possible.

Wetting ability of a liquid is a function of the surface energies of the solid-gas interface, the liquid-gas interface, and the solid-liquid interface. The surface energy across an interface or the surface tension at the interface is a measure of the energy required to form a unit area of new surface at the interface. The intermolecular bonds or cohesive forces between the molecules of a liquid cause surface tension. When the liquid encounters another substance, there is usually an attraction between the two materials. The adhesive forces between the liquid and the second substance will compete against the cohesive forces of the liquid. Liquids with weak cohesive bonds and a strong attraction to another material (or the desire to create adhesive bonds) will tend to spread over the material. Liquids with strong cohesive bonds and weaker adhesive forces will tend to bead-up or form a droplet when in contact with another material.

In liquid penetrant testing, there are usually three surface interfaces involved, the solid-gas interface, the liquid-gas interface, and the solid-liquid interface.

For a liquid to spread over the surface of a part, two conditions must be met. First, the surface energy of the solid-gas interface must be greater than the combined surface energies of the liquid-gas and the solid-liquid interfaces. Second, the surface energy of the solid-gas interface must exceed the surface energy of the solid-liquid interface.

A penetrant's wetting characteristics are also largely responsible for its ability to fill a void or pore. Penetrant materials are often pulled into surface breaking defects by capillary action, which may be defined as the movement of liquid within the spaces of a porous material due to the forces of adhesion, cohesion, and surface tension.

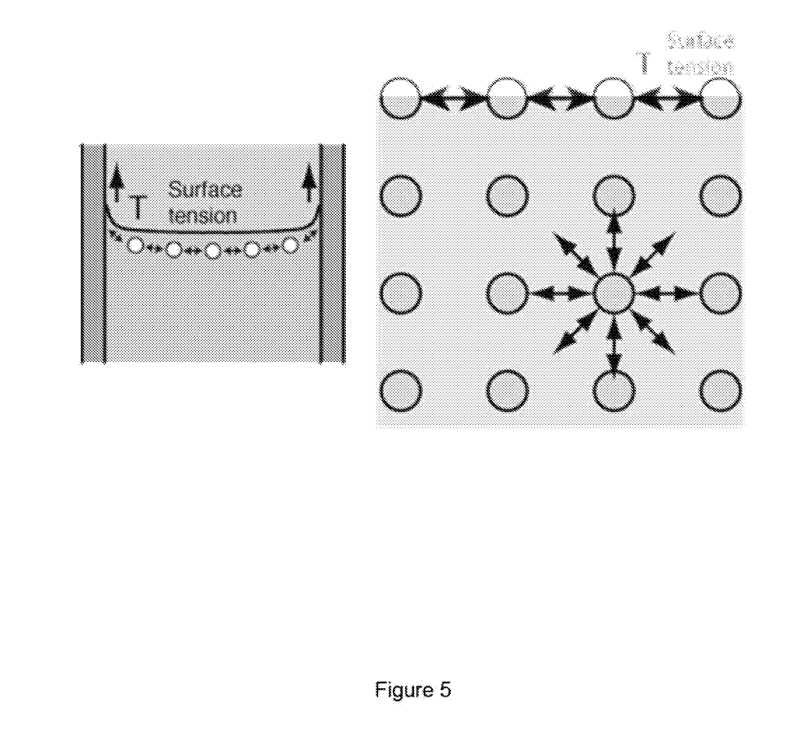

Capillarity can be explained by considering the effects of two opposing forces: adhesion, the attractive (or repulsive) force between the molecules of the liquid and those of the solid, and cohesion, the attractive force between the molecules of the liquid. The size of the capillary action depends on the relative magnitudes of the cohesive forces within the liquid and the adhesive forces operating between the liquid and the pore walls (e.g., as illustrated in FIG. 5).

The forces of cohesion act to minimize the surface area of the liquid. When the cohesive force acting to reduce the surface area becomes equal to the adhesive force acting to increase it, equilibrium is reached and the liquid stops rising where it contacts the solid. Therefore the movement is due to unbalanced molecular attraction at the boundary between the liquid and the solid pores wall. If liquid molecules near the boundary are more strongly attracted to molecules in the material of the solid than to other nearby liquid molecules, the liquid will rise in the tube.

If liquid molecules are less attracted to the material of the solid than to other liquid molecules, the liquid will fall.

The energetic gain from the new intermolecular interactions must be balanced against gravity, which attempts to pull the liquid back down.

The capillary force driving the penetrant into the crack, voids or pores is a function of the surface tension of the liquid-gas interface (O), the contact angle with the solid surface, and the size of the defect opening (pore diameter (d) or radius (r)). The driving force for the capillary action can be expressed as the following formula:

Force=2πrσLG cos θ
Where:
   r=radius of the pore/void opening (2 πr is the line of contact between the liquid and the solid tubular surface.)
   σ LG=liquid-gas surface tension
   θ=contact angle

Since pressure is the force over a given area, it can be written that the pressure developed, called the capillary pressure, is

Capillary Pressure=(2σLG cos θ)/r

The above equations are for a cylindrical defect but the relationships of the variables are the same for a flaw with a noncircular cross section. Capillary pressure equations only apply when there is simultaneous contact of the penetrant along the entire length of the crack opening and a liquid front forms that is equidistant from the surface. A liquid penetrant surface could take-on a complex shape as a consequence of the various deviations from flat parallel walls that an actual pore could have. In this case, the expression for pressure is

Capillary Pressure=2(σSG−σSL)/r=2Σ/r
Where:
σ SG=the surface energy at the solid-gas interface.
σ SL=the surface energy at the solid-liquid interface.
r=the radius of the pore opening.
Σ=the adhesion tension (σ SG−σ SL). Adhesion tension is the force acting on a unit length of the wetting line from the direction of the solid. The wetting performance of the penetrant is degraded when adhesion tension is the primary driving force.

As demonstrated by equations, the surface wetting characteristics (defined by the surface energies) are important in order for a penetrant to fill a void. A liquid penetrant will continue to fill the void until an opposing force balances the capillary pressure. This force is usually the pressure of trapped gas in a void, as most flaws are open only at the surface of the part. Since the gas originally in a flaw volume cannot escape through the layer of penetrant, the gas is compressed near the closed end of a void.

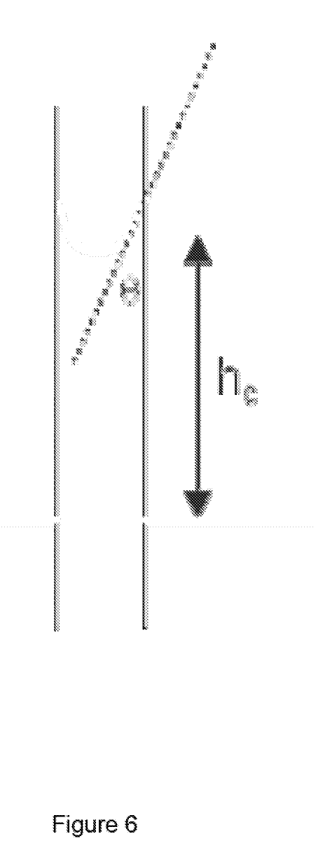

Since the contact angle for penetrants is very close to zero, other methods have been devised to make relative comparisons of the wetting characteristics of these liquids. One method is to measure the height that a liquid reaches in a capillary tube (e.g., as illustrated in FIG. 6).

Capillary rise (height) (hc) is a function of the surface tension of the liquid-gas interface (σ), the contact angle with the solid surface, the size of the defect opening (pore diameter (d)) and specific weights (γL, γG) of liquid and gas. The capillary rise (height) as a result of the capillary action can be expressed as the following formula:

hc=4σ cos(θ)/(γL−γG)d
Since for liquid-vapour interfaces σL>>σG, the equation reduces to:

hc=4σ cos(θ)/γLd

Therefore, the narrower the tube or the smaller the diameter of pore, the higher the liquid will climb or absorbed, because a narrow column of liquid weighs less than a thick one. Likewise the denser a liquid is, the less likely it is to demonstrate capillarity. Capillary action is also less common with liquids which have a very high level of cohesion, because the individual molecules in the fluid are drawn more tightly to each other than they are to an opposing surface. Eventually, capillary action will also reach a balance point, in which the forces of adhesion and cohesion are equal, and the weight of the liquid holds it in place. As a general rule, the smaller the tube, the higher up it the fluid will be drawn. Cohesion force is due to the relative attraction among molecules in a fluid. Since this attraction decreases with increases temperature, the surface tension reduces with increases temperature.

Viscous Flows

Since many of oxygen-sensitive flavoring agents, such as flavor compound, smell flavorant, essential oil, aroma compound and fragrance oil are viscous liquids, the flow rate of such oxygen-sensitive flavoring agents through pores, void, crack will be also dependent on their viscosity. Viscosity is like the internal friction of a fluid. Liquids flow fastest in the center and tend to zero as the wall of the pore is approached. The viscous force is the force necessary to move the top solid surface confining a fluid, when the bottom surface does not move. That force is proportional to the surface area, A, and the velocity, v, and inversely proportional to the distance, d, from the non-moving surface:

F=ηAv/d
η=viscosity of penetrant

The constant coefficient is called coefficient of viscosity, measured in N*s/m², and it depends on the type of fluid. It is 1.0×10⁻³ for water at 20° C. In the cgs system the units of q are dyne*s/cm²=1 poise (from Poiseuille). The conversion is 1 poise=10-1 N s/m², so the coefficient of viscosity of water is also 0.01 poise=1 cp (centipoise).

The flow rate of a penetrant through void, crack, or pore existing on the surface a solid may be obtained through Poiseuille's Law, as follows:

v=Δh/Δt=ΔV/Δt
Where
h=capillary height
v=flow rate
V=volume of penetrant flowing on a pore
t=time
and the rate of flow through a pore of A as:

vA=AΔh/Δt=ΔV/Δt
Where
A=cross sectional area of pore or void

It can be seen that the rate of flow is proportional to the volume of fluid flowing on a pore per unit time.

Poiseuille's law relates this rate of flow to the difference in the pressure, per unit length in the pore (L), necessary to move the flow into the pore:

Rate of Flow=ΔV/Δt=πr4(P1−P2)/(8ηh)
Where:

P1 and P2 are the pressure on the both sides of the pore with opening radius of r separated by a distance h
η=viscosity of penetrant

Notice that if the viscosity is larger, a larger force (a large pressure difference) is needed to push the fluid through the pore or void. More importantly, if there is a restriction, the flow rate decreases as r⁴. So the flow rate of the penetrant is smaller on the small diameter voids or pores than on large diameter ones.

The importance of viscosity can be seen based on Reynolds number. If the flow velocity is large enough and viscosity low enough, the flow may go from laminar (smooth) to turbulent (vortices). This happens experimentally when a non-dimensional parameter, called the Reynolds number, becomes larger than 2,000-3,000. The Reynolds number is defined as:

Re=ρvr/η
Where:
v is the flow velocity for example through a pore of diameter r,
ρ is the density of the fluid, and
η is the coefficient of viscosity.

It can be seen that the Reynolds number measures the ratio of the momentum of the fluid per unit volume (ρv instead of mv), and the viscosity per unit length. When the momentum in the flow is too large compared to the viscosity, the flow is unstable and it becomes chaotic and forms vortices that cannot be dissipated effectively by viscosity. In other words, viscosity is what keeps the flow ordered, and without enough of it, the motion of fluids becomes erratic.

According to some embodiments of the present invention, the absorbent may be a water soluble material possessing high porosity and proper surface tension enabling first the absorption if an emulsion comprising oxygen-sensitive flavoring agents, water and a surfactant and later the absorption of oxygen-sensitive flavoring agents alone when the water is totally evaporated. For some embodiments, examples of absorbent include, but are not limited to monosaccharides such as trioses including ketotriose (dihydroxyacetone) and aldotriose (glyceraldehyde), tetroses such as ketotetrose (erythrulose), aldotetroses (erythrose, threose) and ketopentose (ribulose, xylulose), pentoses such as aldopentose (ribose, arabinose, xylose, lyxose), deoxy sugar (deoxyribose) and ketohexose (psicose, fructose, sorbose, tagatose), hexoses such as aldohexose (allose, altrose, glucose, mannose, gulose, idose, galactose, talose), deoxy sugar (fucose, fuculose, rhamnose) and heptose such as (sedoheptulose), and octose and nonose (neuraminic acid), multiple saccharides such as 1) disaccharides, such as sucrose, lactose, maltose, trehalose, turanose, and cellobiose, 2) trisaccharides such as raffinose, melezitose and maltotriose, 3) tetrasaccharides such as acarbose and stachyose, 4) other oligosaccharides such as fructooligosaccharide (FOS), galactooligosaccharides (GOS) and mannan-oligosaccharides (MOS), 5) polysaccharides such as glucose-based polysaccharides/glucan including glycogen, starch (amylose, amylopectin), hydrogenated starch hydrolysates, corn starch, potato starch, dextrin, dextran, beta-glucan (zymosan, lentinan, sizofiran), and maltodextrin, fructose-based polysaccharides/fructan including inulin, levan beta 2-6, mannose-based polysaccharides (mannan), and galactose-based polysaccharides (galactan), gums such as arabic gum (gum acacia); sugar alcohols such as sorbitol, manitol, mantitol, lactitol, xylitol, isomalt, erythritol; Pharmaburst 500 of SPI Pharma, Pharmaburst C of SPI Pharma, Ludiflash of BASF, Parteck ODT of MERCK CHEMICALS, PEARLITOL Flash of ROQUETTE, PROSOLV ODT of JRS Pharma, and PanExcea ODT MC200G of Mallinckrodt Baker.

Stabilizers and Antioxidants (Oxygen Scavengers)

According to some embodiments, oxygen-sensitive flavoring agents in the core are mixed with a stabilizer or stabilizers. In some implementations, a stabilizer may be selected from the group comprising or consisting of dipotassium edetate, disodium edetate, edetate calcium disodium, edetic acid, fumaric acid, malic acid, maltol, sodium edetate, trisodium edetate. According to some embodiments, the core further comprises an antioxidant or antioxidants. In some implementations, an antioxidant is selected from the group comprising or consisting of L-cysteine hydrochloride, L-cysteine base, 4,4 (2,3 dimethyl tetramethylene dipyrocatechol), tocopherol-rich extract (natural vitamin E), α-tocopherol (synthetic Vitamin E), β-tocopherol, γ-tocopherol, δ-tocopherol, butylhydroxinon, butyl hydroxyanisole (BHA), butyl hydroxytoluene (BHT), propyl gallate, octyl gallate, dodecyl gallate, tertiary butylhydroquinone (TBHQ), fumaric acid, malic acid, ascorbic acid (Vitamin C), sodium ascorbate, calcium ascorbate, potassium ascorbate, ascorbyl palmitate, and ascorbyl stearate.

According to some embodiments of the present invention, the core further comprises both a stabilizer and an antioxidant. Stabilizing agents and antioxidants may optionally be differentiated. According to an embodiment, the antioxidant is L-cysteine hydrochloride or L-cysteine base or tocopherol or polyphenols and/or a combination thereof.

Plasticizers

According to some demonstrative embodiments, a plasticizer, as described herein, may include any suitable additive that may increase the plasticity and/or fluidity of a material, including, for example, polyethylene glycol (PEG), triethyl citrate, triacetin and the like.

Binders

According to some embodiments of the present invention, the core further comprises a binder. Examples of binders include, by way of non-limiting example, Povidone (PVP: polyvinyl pyrrolidone), Copovidone (copolymer of vinyl pyrrolidone and vinyl acetate), polyvinyl alcohol, low molecular weight hydroxypropylmethyl cellulose (HPMC), low molecular weight hydroxypropyl cellulose (HPC), low molecular weight hydroxymethyl cellulose (MC), low molecular weight sodium carboxy methyl cellulose, low molecular weight hydroxyethylcellulose, low molecular weight hydroxymethylcellulose, cellulose acetate, gelatin, hydrolyzed gelatin, polyethylene oxide, acacia, dextrin, starch, and water soluble polyacrylates and polymethacrylates, low molecular weight ethylcellulose or a mixture thereof. In an embodiment, the binder is low molecular weight HPMC.

Hydrophilic Water Soluble Polymer

According to some embodiments of the present invention, the emulsion/suspension of oxygen-sensitive flavoring agents may further include a hydrophilic water soluble polymer enhancing the absorption and adhesion of the flavoring agents into the water soluble absorbent pores and preventing the destruction of the water soluble absorbent which may occur by the emulsion.

Examples of hydrophilic water soluble polymer include, by way of non-limiting example, Povidone (PVP: polyvinyl pyrrolidone), Copovidone (copolymer of vinyl pyrrolidone and vinyl acetate), polyvinyl alcohol, low molecular weight hydroxypropylmethyl cellulose (HPM), low molecular weight hydroxymethyl cellulose (MC), low molecular weight sodium carboxy methyl cellulose, low molecular weight hydroxyethylcellulose, low molecular weight hydroxymethylcellulose, cellulose acetate, gelatin, hydrolyzed gelatin, polyethylene oxide, acacia, dextrin, starch, and water soluble polyacrylates and polymethacrylates, low molecular weight ethylcellulose or a mixture thereof. In an embodiment, the hydrophilic water soluble polymer is low molecular weight HPMC.

Surfactant

According to some embodiments of the present invention, the core may further comprise a surfactant. The surfactant may be an emulsifier (emulsifying agent), suspending agent, dispersing agent, and/or any other food grade surface active agents, such as, by way of non-limiting example, docusate sodium, sodium lauryl sulfate, glyceryl monooleate, polyoxyethylene sorbitan fatty acid esters, polyvinyl alcohol, sorbitan esters, etc., and/or a combination or combinations thereof.

Other Food-Grade Ingredients

According to some demonstrative embodiments, the other food-grade ingredients, as referred to herein, may include any suitable additive(s) including, for example, a surfactant, an anti-glidant, a binder, and/or any other component described herein, or any combination thereof.

First Coating Layer

According to some embodiments, particles of said core are coated with an inner coating layer whose aqueous solution of 0.1% has a surface tension lower than 60 mN/m, in some embodiments lower than 50 mN/m and in further embodiments lower than 45 mN/m (measured at 25° C.), for adjusting surface tension for further coating with outer coating layer. The first layer helps also to resist the oxygen, water and humidity penetration into the granules during the preparation of the encapsulation process of granular/particular oxygen-sensitive flavoring agents.

Such a first layer should also be readily water soluble in order to prevent the possibility of hindering flavors release in the mouth cavity. It is also most preferable that such a first coating layer is implemented by a hot melt coating method whereby the use of any solvent is prevented the fact that enables coating at relatively low temperature thus the possibility of evaporation of flavoring agent will be avoided or diminished. This is especially important where a volatile flavoring agent is of interest to be encapsulated.

Such a first layer is preferably needed where the encapsulated oil is highly hydrophobic/lipophilic in such a way that the direct implementation of the outer layer onto the absorbent, which is previously absorbed by the oil, is practically impossible. The lack of adhesion of the outer layer directly onto the absorbent is the result of a high interfacial tension between both the outer as well as absorbent surfaces. Thus for adjusting the interfacial tension and making the adhesion of the outer layer onto the absorbent such an intermediate layer (First coating layer) is needed.

According to some important embodiments one of the most applicable polymer for producing such a first coating layer is poloxamer. The poloxamer polyols are a series of closely related blockcopolymers of ethylene oxide and propylene oxide conforming to the general formula HO(C₂H₄O)ₐ(C₃H₆O)_{b}(C₂H₄O)ₐH.

Chemical Composition:

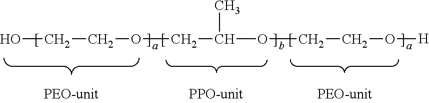

Trade names include Pluronic, Lutrol and Synperonic.

The grades included in the PhEur 6.0 and USP32-NF27 are shown in Table below.

The PhEur 6.0 states that a suitable antioxidant may be added.

| | | | | | Melting | |
|---|---|---|---|---|---|---|
| | | Physical | | | point | Molecular |
| Lutrol F | Poloxamer | Form | a | b | ° C. | weight |
| L 44 | 124 | Liquid | 12 | 20 | 16 | 2090-2360 |
| F 68 | 188 | Solid | 80 | 27 | 52-57 | 7680-9510 |
| F 87 | 237 | Solid | 64 | 37 | 49 | 6840-8830 |
| F 108 | 338 | Solid | 141 | 44 | 57 | 12700-17400 |
| F 127 | 407 | Solid | 101 | 56 | 52-57 | 9840-14600 |

The solubility of poloxamer varies according to the poloxamer type. All poloxamer grades as mentioned in the above table are freely water soluble.

As discussed herein, surface tension (ST) is a property of the surface of a liquid that allows it to resist an external force, that is, surface tension is the measurement of the cohesive (excess) energy present at a gas/liquid interface. The molecules of a liquid attract each other. The interactions of a molecule in the bulk of a liquid are balanced by an equally attractive force in all directions. Molecules on the surface of a liquid experience an imbalance of forces as indicated below. The net effect of this situation is the presence of free energy at the surface. The excess energy is called surface free energy and can be quantified as a measurement of energy/area. It is also possible to describe this situation as having a line tension or surface tension, which is quantified as a force/length measurement. The common units for surface tension are dynes/cm or mN/m (these units are equivalent).

Polar liquids, such as water, have strong intermolecular interactions and thus high surface tensions. Any factor which decreases the strength of this interaction will lower surface tension. Thus an increase in the temperature of this system will lower surface tension. Any contamination, especially by surfactants, will lower surface tension and lower surface free energy. Some surface tension values of common liquids and solvents are shown in the following table.

| Substance | γ (mN/m) | γp (mN/m) | γd (mN/m) |
|---|---|---|---|
| Water | 72.8 | 51.0 | 21.8 |
| Glycerol | 64 | 30 | 34 |
| Ethylene glycol | 48 | 19 | 29 |
| Dimethyl sulfoxide | 44 | 8 | 36 |
| Benzyl alcohol | 39 | 11.4 | 28.6 |
| Toluene | 28.4 | 2.3 | 26.10 |
| Hexane | 18.4 | — | 18.4 |
| Acetone | 23.7 | — | 23.7 |
| Chloroform | 27.15 | — | 27.15 |
| Diiodomethane | 50.8 | — | 50.8 |

The adhesion and uniformity of a film are also influenced by the forces which act between the coating formulation that is in a solution form and the core surface of the film coated surface. Therefore, coating formulations for certain core surface can be optimized via determination of wetting behavior, the measure of which is the contact or wetting angle. This is the angle that forms between a liquid droplet and the surface of the solid body to which it is applied.

The adhesion and uniformity of a film are also influenced by the forces which act between the coating formulation which is in a solution form and the core surface of the film coated surface. Therefore, coating formulations for certain core surface can be optimized via determination of wetting behavior, the measure of which is the contact or wetting angle. This is the angle that forms between a liquid droplet and the surface of the solid body to which it is applied.

When a liquid does not completely spread on a substrate (usually a solid) a contact angle (θ) is formed which is geometrically defined as the angle on the liquid side of the tangential line drawn through the three phase boundary where a liquid, gas and solid intersect, or two immiscible liquids and solid intersect. The contact angle is a direct measure of interactions taking place between the participating phases. The contact angle is determined by drawing a tangent at the contact where the liquid and solid intersect.

The contact angle is small when the core surface is evenly wetted by spreading droplets. If the liquid droplet forms a defined angle, the size of the contact angle may be described by the Young-Dupre equation:

γSG−γSL=^{γ}LG cos θ
Where
θ=Contact angle
γSG=surface tension of the solid body
γLG=surface tension of the liquid
γSL=interfacial tension between liquid and solid body (cannot typically be measured directly)

With the aid of this equation it is possible to estimate the surface tension of a solid body by measuring the relevant contact angles. If one measures them with liquid of varying surface tension and plots their cosines as a function of the surface tension of the liquids, the result is a straight line. The abscissa value of the intersection of the straight line with cos θ=1 is referred to as the critical surface tension of wetting γC.

A liquid with a surface tension smaller than γC wets the solid in question.

In some embodiments, the wetting or contact angle can be measured by means of telescopic goniometers (e.g. LuW Wettability Tester by AB Lorentzenu. Wettre, S-10028 Stockholm 49). In some cases, the quantity γC does not suffice to characterize polymer surfaces since it depends on, amongst other factors, the polar character of the test liquids. This method can, however, be improved by dividing γ into non-polar part yd (caused by dispersion forces) and a polar part γp (caused by dipolar interactions and hydrogen bonds):

γL=γLp+γLd

γS=γSp+γSd
Where
γL=surface tension of the test liquid
γS=surface tension of the solid body

And γSp and γSd can be determined by means of the following equation:

1+(cos θ/2)(γL/√γLd)=√γSd+√γSp·√(γL−γLd)/γLd

If 1+(cos θ/2)(γL/√γLd) is plotted against √(γL−γLd)/·Ld, straight lines are obtained from the slopes and ordinate intercepts of which γSp and γSd can be determined and thus γS calculated. γC and γS are approximately, but not exactly, the same. Since the measurement is also influenced by irregularities of the polymer surfaces, one cannot typically obtain the true contact angle θ but rather the quantity θ′. Both quantities are linked by the relationship:

Roughness factor r=cos θ′/cos θ

The lower the surface tension of the coating formulation against that of the core surface, the better the droplets will spread on the surface. If formulations with organic solvents are used, which may wet the surface very well, the contact angle will be close to zero, and the surface tensions of such formulations are then about 20 to 30 mN/m. Aqueous coating dispersion of some polymer like EUDRAGIT L 30 D type shows low surface tension in the range of 40 to 45 mN/m.

In summary, contact angle measurements discussed herein with reference to some embodiments of the present invention provide the following information:

Smaller contact angles give smoother film coatings.

The contact angle becomes smaller with decreasing porosity and film former concentration.

Solvents with high boiling point and high dielectric constant reduce the contact angle.

The higher the critical surface tension of core, the better the adhesion of the film to the core.

The smaller the contact angle, the better the adhesion of the film to the core.

The critical surface tension of the core or granules saturated with hydrophobic flavoring agent oil is essentially very low. Therefore, for providing better spreading and thus better adhesion of the outer coating layer film to the core there is a need for reducing the surface free energy at the interface between the surface of the fat coated core/granules and the solution of the outer coating layer polymer.

According to some embodiments, particles of said core saturated with hydrophobic flavoring agent oil are coated with an inner coating layer whose aqueous solution of 0.1% has a surface tension lower than 60 mN/m, in some embodiments lower than 50 mN/m and in further embodiments lower than 45 mN/m (measured at 25° C.), for reducing the surface free energy at the interface between the surface of the core/granules and the solution of the outer coating layer polymer.

The following table shows for example the surface tension of the solution of some water soluble polymers. The Surface tension was measured at 25° C., 0.1% aqueous solution of the polymers.

| Polymer | Surface Tension mN/m |
|---|---|
| Sodium Carboxymethylcellulose (Na-CMC) | 71.0 |
| Hydroxyethyl cellulose (HEC) | 66.8 |
| Hydroxypropyl cellulose (HPC) | 43.6 |
| Hydroxypropyl methyl cellulose (HPMC) | 46-51 |
| Hydroxymethyl cellulose (HMC) | 50-55 |

Forth beneath are examples of the surface tension of poloxamers 188;
For a 0.1% w/v aqueous poloxamer 188 solution at 25° C.—the surface tension is 19.8 mN/m (19.8 dynes/cm); For a 0.01% w/v aqueous poloxamer 188 solution at 25° C. the surface tension is 24.0 mN/m (24.0 dynes/cm); For a 0.001% w/v aqueous poloxamer solution at 25° C. the surface tension is 26.0 mN/m (26.0 dynes/cm).

Examples of polymers which may be used as first coating layer include, by way of non-limiting example, a water-soluble cellulosic polymer which is a hydroxy or carboxy mono- or di-(C1-4) alkyl cellulose polymer such as hydroxypropyl cellulose (HPC), hydroxypropylethylcellulose (HPEC), hydroxymethylpropylcellulose (HMPC), hyhroxypropylmethylcellulose (HPMC), ethylhydroxyethylcellulose (EHEC) (Ethulose), hydroxyethylmethylcellulose (HEMC), hydroxymethylethylcellulose (HMEC), propylhydroxyethylcellulose (PHEC), methylhydroxyethylcellulose (MHEC), hydrophobically modified hydroxyethylcellulose (NEXTON), carboxymethylhydroxyethylcellulose (CMHEC), water soluble vinyl acetate copolymers, poloxamers, gums, polysaccharides such as alginic acid and alginates such as ammonia alginate, sodium, potassium, and/or a combination or combinations thereof.

Outer Layer

According to some embodiments, an outer coating layer may comprise a polymer (or polymers) having an oxygen transmission rate of less than 1000 cc/m²/24 hr, in some embodiments less than 500 cc/m²/24 hr and in further embodiments less than 100 cc/m²/24 hr, measured at standard test conditions (i.e. 73° F. (23° C.) and 0% RH), and a water vapor transmission rate of less than 400 g/m²/day, in some embodiments less than 350 g/m²/day, and in further embodiments less than 300 g/m²/day, coats said coated particles having an adjusted surface for reducing or preventing the transmission of oxygen and humidity into the core, thereby obtaining a multiple-layered particle containing oxygen-sensitive flavoring agents and demonstrating improved stability against both oxygen as well as humidity.

Water Vapor Permeability (WVP) of Films

For some embodiments, the water vapor permeability is an important property of most outer layer coating films, mainly because of the importance of the role of water in deteriorative reactions.

Water acts as a solvent or carrier and can cause texture degradation, chemical and enzymatic reactions and is thus destructive of oxygen-sensitive flavoring agents. Also the water activity of foods is an important parameter in relation to the shelf-life of the food and food-containing oxygen-sensitive flavoring agents. In low-moisture foods and oxygen-sensitive flavoring agents, low levels of water activity must be maintained to minimize the deteriorative chemical and enzymatic reactions and to prevent the texture degradation. The composition of film forming materials (hydrophilic and hydrophobic character), temperature and relative humidity of the environment affect the water vapor permeability of the films. When considering a suitable barrier in foods containing oxygen-sensitive flavoring agents, the barrier properties of the films may be important parameters.

Polysaccharide films and coatings may generally be good barriers against oxygen and carbon dioxide and have good mechanical properties but their barrier property against water vapor is poor because of the their hydrophilic character.

To add an extra hydrophobic component, e.g. a lipid (waxes, fatty acids), in the film and produce a composite film is one way to achieve a better water vapor barrier. Here the lipid component serves as the barrier against water vapor. By adding a lipid, the hydrophobicity of the film is increased and as a result of this case, water vapor barrier property of the film increases. The amount of hydrophobic component must, however, be in such amounts that do not damage the capability of fast dissolution of the whole formula.

Water Vapor Permeability of a film is a constant that should be independent of the driving force on the water vapor transmission. When a film is under different water vapor pressure gradients (at the same temperature), the flow of water vapor through the film differs, but their calculated permeability should be the same. This behavior does not happen with hydrophilic films where water molecules interact with polar groups in the film structure causing plasticization or swelling.

Another assumption inherent to the calculation of permeability is its independence from film thickness. This assumption may not be true for hydrophilic films and because of that, experimentally determined water vapor permeability of many films applied only to the specific water vapor gradients used during testing and for the specific thickness of the tested specimens, use of the terms “Effective Permeability” or “Apparent Permeability” may be appropriate.

Moisture transport mechanism through a composite depends upon the material and environmental conditions. Permeability has two different features in the case of composites. First, in non-porous membranes, permeation can occur by solution and diffusion, and the other, simultaneous permeation through open pores is possible in a porous membrane.

There are various methods of measuring permeability. Weight loss measurements are of importance to determine permeability characteristics. Water vapor permeability may be determined by direct weighing because, despite its inherent problems, mainly related to water properties such as high solubility and cluster formation within the polymer and tendency to plasticize the polymer matrix, it can be a straightforward and relatively reliable method. The major disadvantage of this method resides in its weakness to provide information for a kinetic profile when such a response is required.

Another measurement method is based on the standard described in ASTM E96-80 (standard test method procedure for water vapor permeability).

According to this method, water vapor permeability is determined gravimetrically and generally the applied procedures are nearly the same in many research papers that are related with this purpose. In this procedure firstly, the test film is sealed to a glass permeation cell which contain anhydrous calcium chloride (CaCl2), or silica gel (Relative vapor pressure; RVP=0) and then the cell is placed in the desiccators maintained at specific relative humidity and temperature (generally 300 C, 22% RH) with magnesium nitrate or potassium acetate. Permeation cells are continuously weighed and recorded, and the water vapor that transferred through the film and absorbed by the desiccant are determined by measuring the weight gain. Changes in weight of the cell were plotted as a function of time. When the relationship between weight gain (Δw) and time (Δt) is linear, the slope of the plot is used to calculate the water vapor transmission rate (WVTR) and water vapor permeability (WVP). Slope is calculated by linear regression and correlation coefficient (r2>>0.99).

The WVTR is calculated from the slope (Δw/Δt) of the straight line divided by the test area (A), (g s−1 m−2):

WVTR=Δw/(Δt·A)(g·m−2·s−1)
Where
Δw/Δt=transfer rate, amount of moisture loss per unit of time (g·s−1)
A=area exposed to moisture transfer (m2)

The WVP (kg Pa−1 s−1 m−1) is calculated as:

WVP=[WVTR/S(R1−R2)]·d
Where
S=saturation vapor pressure (Pa) of water at test temperature,
R1=RVP (relative vapor pressure) in the desiccator,
R2=RVP in the permeation cell, and
d=film thickness (m).

In some embodiments, at least three replicates of each film should be tested for WVP and all films should be equilibrated with specific RH before permeability determination.

The water vapor permeability can also be calculated from the WVTR as follows:

P=WVTR·L/Δp (g/m̂2·s·Pa)
Where
L=film thickness (m)
Δp=water vapor pressure gradient between the two sides of the film (Pa)
P=film permeability (g·m−2·s−1Pa−1)

The rate of permeation is generally expressed by the permeability (P) rather than by a diffusion coefficient (D) and the solubility (S) of the penetrant in the film. When there is no interaction between the water vapor and film, these laws can apply for homogeneous materials. Then, permeability follows a solution-diffusion model as:

P=D·S
Where D is the diffusion coefficient and the S is the slope of the sorption isotherm and is constant for the linear sorption isotherm.

The diffusion coefficient describes the movement of permeant molecule through a polymer, and thus represents a kinetic property of the polymer-permeant system.

As a result of the hydrophilic characteristics of polysaccharide films, the water vapor permeability of films is related to their thickness. The permeability values increase with the increasing thickness of the films.

Thickness of films and the molecular weight (MW) of the film forming polymers may also affect both water vapor permeability (WVP) and oxygen permeability (OP) of the films.

Oxygen Transmission Determination (OTR)

Oxygen transmission rate is the steady-state rate at which oxygen gas permeates through a film at specified conditions of temperature and relative humidity. Values are expressed in cc/100 in²/24 hr in US standard units and cc/m²/24 hr in metric (or SI) units.

Gas permeability, especially oxygen permeability, of the polymer may indicate the protective function of the polymer as a barrier against oxygen transmission.

Such polymers which demonstrate low oxygen permeability can be used as outer layer. For the purpose of the FLAVORCAPS as discussed herein, the relevant gas for improved stability of the oxygen-sensitive flavoring agents is oxygen. The viability of oxygen-sensitive flavoring agents may be significantly reduced upon exposing to oxygen. Therefore, for providing long term stability and receiving an extended shelf life for oxygen-sensitive flavoring agents, the outer layer should provide a significant oxygen barrier.

The gas permeability, q, (ml/m̂2·day·atm) (DIN 5380) is defined as the volume of a gas converted to 0° C. and 760 torr which permeates 1 m̂2 of the film to be tested within one day at a specific temperature and pressure gradient. It may therefore be calculated according to the following formula:

q={To·Pu/[Po·T·A(Pb−Pu)]}·24·Q·(Δx/Δt)·10̂4
Where
Po=normal pressure in atm
To=normal temperature in K
T=experimental temperature in K
A=sample area in m̂2
T=time interval in hrs between two measurements
Pb=atmospheric pressure in atm
Pu=pressure in test chamber between sample and mercury thread
Q=cross section of capillaries in cm
Δx/Δt=sink rate of the mercury thread in cm/hr

The following table shows Oxygen Transmission rate (OTR) and Water vapor Transmission rate (WVTR) of some example water soluble polymers.

| | Oxygen | Water vapor |
|---|---|---|
| Film Forming | Transmission rate, | Transmission rate, |
| Polymer | Cm\hat{ }3/m2/atm O2 day | g/m2/day |
| HPC, Klucel EF | Medium | Low |
| | 776 | 126 |
| CMC, Aqualon or | Low | Low |
| Blanose 7 L | 18 | 228 |
| HEC, Natrosol 250 L | Low | Medium |
| | 33 | 360 |
| HPMC 5 cps | High | High |
| | 3180 | 420 |

Non-limiting examples of outer layer coating polymer include water-soluble, hydrophilic polymers, such as, for example, polyvinyl alcohol (PVA), Povidone (PVP: polyvinyl pyrrolidone), Copovidone (copolymer of vinyl pyrrolidone and vinyl acetate), Kollicoat Protect (BASF) which is a mixture of Kollicoat IR (a polyvinyl alcohol (PVA)-polyethylene glycol (PEG) graft copolymer) and polyvinyl alcohol (PVA), Opadry AMB (Colorcon) which is a mixture based on PVA, Aquarius MG which is a cellulosic-based polymer containing natural wax, lecithin, xanthan gum and talc, low molecular weight HPC (hydroxypropyl cellulose), low molecular weight carboxy methyl cellulose such as 7LF or 7L2P, or a mixture/mixtures thereof. In some embodiments, mixture(s) of water soluble polymers with insoluble agents such as waxes, fats, fatty acids, and/or the like, may be utilized.

In some embodiments, the outer coating polymer(s) are carboxy methyl 1 cellulose such as 7LF or 7L2P, polyvinyl alcohol, Kollicoat Protect (BASF) which is a mixture of Kollicoat IR (a polyvinyl alcohol (PVA)-polyethylene glycol (PEG) graft copolymer) and polyvinyl alcohol (PVA) and silicon dioxide, Opadry AMB (Colorcon) which is a mixture based on PVA, and Aquarius MG which is a cellulosic-based polymer containing natural wax. Theses polymers may provide superior barrier properties against water vapor/humidity and/or oxygen penetration into the core or granules.

In some embodiments, the outer coating layer provides barrier properties against oxygen penetration and the next outer and/or outermost coating layer provides barrier properties against water vapor/humidity penetration. In some other embodiments the outer coating layer provides barrier properties against water vapor/humidity penetration and the next outer and/or outermost coating layer provides barrier properties against oxygen penetration.

### Example 1

### Microencapsulation of Lemon Oil

300 g of maltodextrin M15 granulated were used as absorbent. A solution of lemon oil in ethanol was prepared based on the following composition:
Lemon oil=65 g
Ethanol=65 g
Tocopherol (Tocopheryl acetate)=0.065 g

Maltodextrin and 4 g aerosol were first loaded into Innojet-IEV2.5 V2, and heated at 40° C. for 30 minutes while fluidizing prior to spraying the solution. The solution was then sprayed on maltodextrin using nitrogen as an inert gas.

After spraying all of the solution, lemon oil-absorbed maltodextrin was discharged from the container of Innojet-IEV2.5 V2 and sieved. Then lemon oil-absorbed maltodextrin (369 g) was re-loaded and a solution of HPC ELF (5% W/W) in ethanol (95% W/W) and purified water (5% W/W) was sprayed using nitrogen as an inert gas to result in HPC coated particles. The process was stopped after reaching a weight gain of about 5% (W/W). Finally, the aqueous solution (5% w/w) of Na-carboxy methyl cellulose 7L2P and polyethylene glycol (PEG 400, 25% w/w) was sprayed onto the above resulting HPC coated particles to reach weight gain of 40% of Na-carboxymethyl cellulose. Samples at points of 10%, 20% and 30% weight gain were taken for an accelerated oxidation stability test. The final product was dried and kept in a double sealed polyethylene bag with a proper desiccant in a refrigerator.

### Example 2

### Microencapsulation of Peach Oil in Propylene Glycol

300 g of sorbitol were used as water soluble absorbent. An emulsion was prepared based on the following composition:
Peach oil in propylene glycol=150 g
HPMC E3 (5% in water)=350 g (17.5 g hydroxypropyl methyl cellulose+332.5 g H2O)
Tween 80=5 g
Tocopherol=0.15 g

Sorbitol was first loaded into Innojet-IEV2.5 V2, and heated at 40° C. for 30 minutes while fluidizing prior to spraying the emulsion. The emulsion was then sprayed on sorbitol using nitrogen as an inert gas. The inlet temperature was continuously kept at 40° C.

The process finished, yielding 472.7 g solidified peach oil particles (peach oil absorbed-sorbitol). 300 g of peach oil absorbed-sorbitol were then loaded into an Innojet coater and 5% solution of hydroxypropyl cellulose ELF in a mixture of water and ethanol (15.85 g HPC in 301.15 g of a mixture of water ethanol which was previously prepared) was sprayed using nitrogen as an inert gas. The process was stopped after reaching a weight gain of about 15 g yielding 315 g. Then 300 g of the HPC coated particles were reloaded into Innojet-IEV2.5 V2 and an aqueous solution of carboxymethyl cellulose (CMC 7L2P) (4%) and polyethylene glycol 400 (PEG 400) (1%), (96.5 g CMC and 24.14 g PEG in 2291 g H2O) was sprayed onto the above resulting HPC coated particles to reach weight gain of 40% of Na-carboxymethyl cellulose. Samples were taken after reaching 10%, 20% and 30% weight gain for accelerated oxidation stability test.

The final product has the following composition:

| Component | Content (%) |
|---|---|
| Sorbitol | 43.2 |
| Peach oil in propylene glycol | 21.3 |
| HPMC E3 | 2.5 |
| Tween 80 | 0.7 |
| Tocopherol | 0.026 |
| HPC ELF | 3.6 |
| CMC 7L2P | 23 |
| PEG 400 | 5.7 |

The final product was dried and kept in a double sealed polyethylene bag with a proper desiccant in a refrigerator.

### Example 3

### Microencapsulation of Lemon Oil

300 g of sorbitol were used as water soluble absorbent. An emulsion was prepared based on the following composition:
Lemon oil=150 g
HPMC E3 (5% in water)=350 g (17.5 g hydroxypropyl methyl cellulose+332.5 g H2O)

Tween=5 g

Tocopherol=0.2 g

Sorbitol was first loaded into Innojet-IEV2.5 V2, and heated at 40° C. for 30 minutes while fluidizing prior to spraying the emulsion. The emulsion was then sprayed on sorbitol using nitrogen as an inert gas. The inlet temperature was continuously kept at 40° C.

The process finished, yielding 472.7 g solidified lemon oil particles (lemon oil absorbed-sorbitol).

300 g of lemon oil absorbed-sorbitol were then loaded into an Innojet coater and 5% solution of hydroxypropyl cellulose ELF in a mixture of water and ethanol (15.85 g HPC in 301.15 g of a mixture of water ethanol which was previously prepared) were sprayed using nitrogen as an inert gas. The process was stopped after reaching a weight gain of about 15 g yielding 315 g. Then 300 g of the HPC coated particles reloaded into Innojet-IEV2.5 V2 and an aqueous solution of carboxymethyl cellulose (CMC 7L2P) (4%) and polyethylene glycol 400 (PEG 400) (1%), (96.5 g CMC and 24.14 g PEG in 2291 g H2O) was sprayed onto above the resulting HPC coated particles to reach weight gain of 40% of Na-carboxymethyl cellulose. Samples were taken after reaching 10%, 20% and 30% weight gain for accelerated oxidation stability test.

The final product has the following composition:

| Component | Content (%) |
|---|---|
| Sorbitol | 43.2 |
| Lemon oil | 21.3 |
| HPMC E3 | 2.5 |
| Tween | 0.7 |
| Tocopherol | 0.03 |
| HPC ELF | 3.6 |
| CMC 7L2P | 23 |
| PEG 400 | 5.7 |

The final product was dried and kept in a double sealed polyethylene bag with a proper desiccant in a refrigerator.

### Example 4

### Microencapsulation of Bergamot Powder as a Flavoring Agent

187.5 g sorbitol as a water soluble absorbent and 112.5 g bergamot powder were loaded into Innojet-IEV2.5 V2 and mixed for about 5 minutes. The mixture was preheated to 40° C. Then a solution of 5% of HPMC E3 (23.25 g) in water was prepared. 3.6 g tween and 0.186 g tocopherol were added into the HPMC solution and the solution was then homogenized. The resulting solution was then sprayed onto the above resulting powder mixture to result in dry granules of bergamot powder. The resulting bergamot powder granules were coated by the first coating layer. For this purpose a 5% solution of HPC ELF in water was prepared containing 30.1 g HPC. The above resulting solution was sprayed onto the above resulting bergamot powder granules at 40° C. to obtain a weight gain of about 10% W/W. The above resulting HPC coated granules were then coated by the outer layer composing of CMC. For this purpose 300 g of the above resulting HPC coated granules were reloaded into Innojet-IEV2.5 V2 and an aqueous solution of carboxymethyl cellulose (CMC 7L2P) (4%) and polyethylene glycol 400 (PEG 400) (1%), (96.44 g CMC and 24.1 g PEG in 2298.5 g H2O) was sprayed onto the HPC coated granules to reach weight gain of 40% of Na-carboxymethyl cellulose. Samples were taken after reaching 10%, 20% and 30% weight gain for accelerated oxidation stability test.

The final product has the following composition:

| Component | Content (%) |
|---|---|
| Sorbitol | 36.9 |
| Lemon oil | 22.2 |
| HPMC E3 | 4.6 |
| Tween | 0.7 |
| Tocopherol | 0.03 |
| HPC ELF | 6.4 |
| CMC 7L2P | 23.3 |
| PEG 400 | 5.8 |

The final product was dried and kept in a double sealed polyethylene bag with a proper desiccant in a refrigerator.

### Example 5

### Microencapsulation of Lemon Oil

300 g of sorbitol were used as water soluble absorbent. An emulsion was prepared based on the following composition:
Lemon oil=150 g
HPMC E3 (5% in water)=350 g (17.5 g hydroxypropyl methyl cellulose+332.5 g H2O)
Tween 80=5 g
Tocopherol=0.2 g
Sorbitol was first loaded into Innojet-IEV2.5 V2, and heated at 40° C. for 30 minutes while fluidizing prior to spraying the emulsion. The emulsion was then sprayed on sorbitol using nitrogen as an inert gas. The inlet temperature was continuously kept at 40° C.

The process finished, yielding 472.7 g solidified lemon oil particles (lemon oil absorbed-sorbitol).

321 g of lemon oil absorbed-sorbitol were then loaded into Innojet coater and 70 g Poloxamer 188 (Lutrol 68F) (which was previously melted at 60° C.) was sprayed. The process was stopped after reaching a weight gain of about 70 g.

300 g of lemon oil absorbed-sorbitol coated by Poloxamer 188 were then loaded into Innojet IEV2.5 V2 coater and an aqueous solution of carboxymethyl cellulose (CMC 7L2P) (4%) and polyethylene glycol 400 (PEG 400) (1%), (96.5 g CMC and 24.14 g PEG in 2291 g H2O) was sprayed onto above resulting Poloxamer coated particles to reach weight gain of 40% of Na-carboxymethyl cellulose. Samples were taken after reaching 10%, 20% and 30% weight gain for accelerated oxidation stability test.

The final product has the following composition:

| Component | Content (%) |
|---|---|
| Sorbitol | 30.9 |
| Lemon oil | 15.4 |
| HPMC E3 | 1.7 |
| Tween 80 | 0.5 |
| Tocopherol | 0.017 |
| Poloxamer | 10.6 |
| CMC 7L2P | 32.7 |
| PEG 400 | 8.1 |

The final product was dried and kept in a double sealed polyethylene bag with a proper desiccant in a refrigerator.

Oxidation Test

An oxidation test method was used to evaluate the capability of the final product resulting from Example 1 to withstand oxidation during the shelf life. For this purpose, an accelerated oxidation test method was used. The method was based on an OXIPRES™ method. The ML OXIPRES™ (MIKROLAB AARHUS A/S Denmark) method is a modification of the bomb method, which is based on oxidation with oxygen under pressure. The test is accelerated when carried out at elevated pressure and temperature.

The consumption of oxygen, which means that oxidation process occurs, is determined by the pressure drop in the pressure vessel during the experiment. The time at which the oxygen pressure started to drop is called the Induction Period. A longer Induction Period means that the protection against oxidation process is higher, indicating that the contents of the microcapsules, prepared according to embodiments of FLAVORCAPS, are better protected towards oxidation process.

Results

The capability of microencapsulated lemon oil samples from Example 1 as compared to lemon oil to withstand oxidation was evaluated using ML OXIPRES™ test method at elevated temperature and under an initial oxygen pressure of 5 bar. Microencapsulated lemon oil samples of 10 grams for each pattern were used for the test. A lemon oil sample of 5 g was used for the test for comparison. The results, shown by Induction Period, are summarized below in Table 1.

TABLE 1
Induction Periods of different samples prepared
according to an exemplary embodiment of FLAVORCAPS
(Example 1) as compared to lemon oil as-is.

| | Test | Induction |
|---|---|---|
| | Temperature | Period |
| Sample | (° C.) | (Hours) |
| Microencapsulated lemon oil 10% weight gain | 90 | >240 |
| Microencapsulated lemon oil 20% weight gain | 90 | >240 |
| Microencapsulated lemon oil 30% weight gain | 90 | >240 |
| Microencapsulated lemon oil 40% weight gain | 90 | >240 |
| lemon oil | 90 | 5.0-10 |

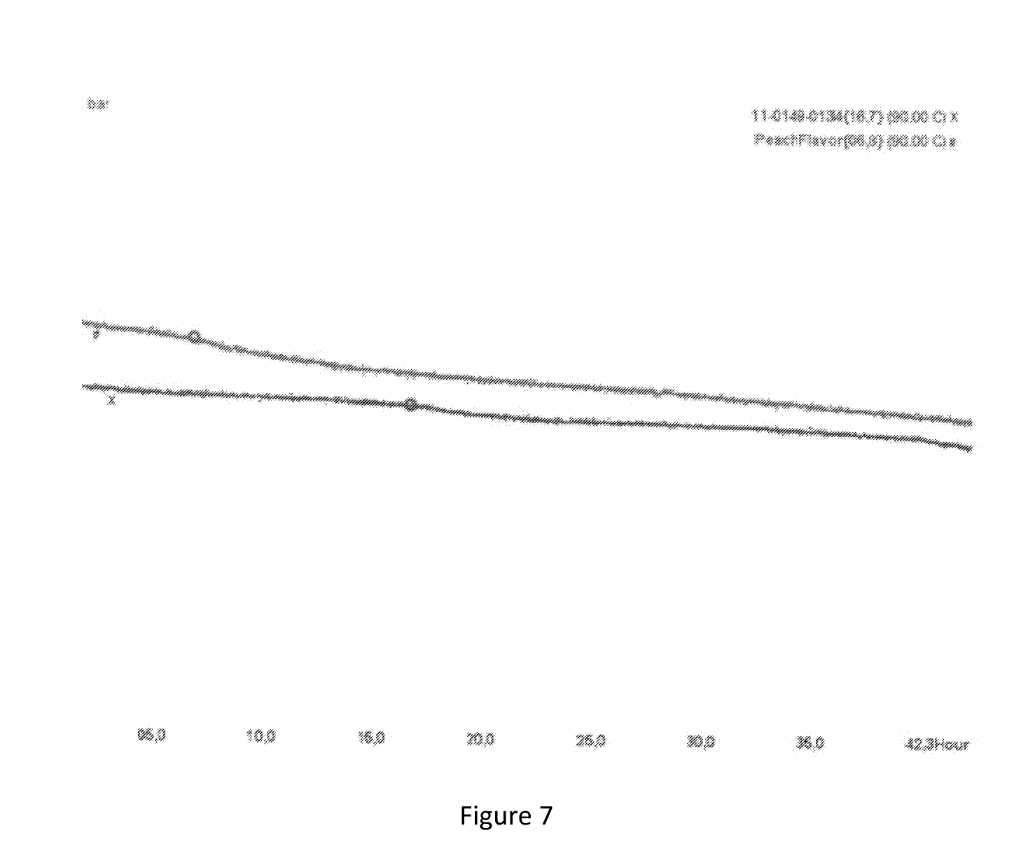

The capability of microencapsulated peach oil in propylene glycol sample from Example 2 as compared to peach oil in propylene glycol to withstand oxidation was evaluated using ML OXIPRES™ test method at 90° C. and under an initial oxygen pressure of 5 bar. Samples of 10 grams for microencapsulated peach oil were used for each test. A peach oil in propylene glycole sample of 5 g was used for the test for comparison. The results are shown in FIG. 7.

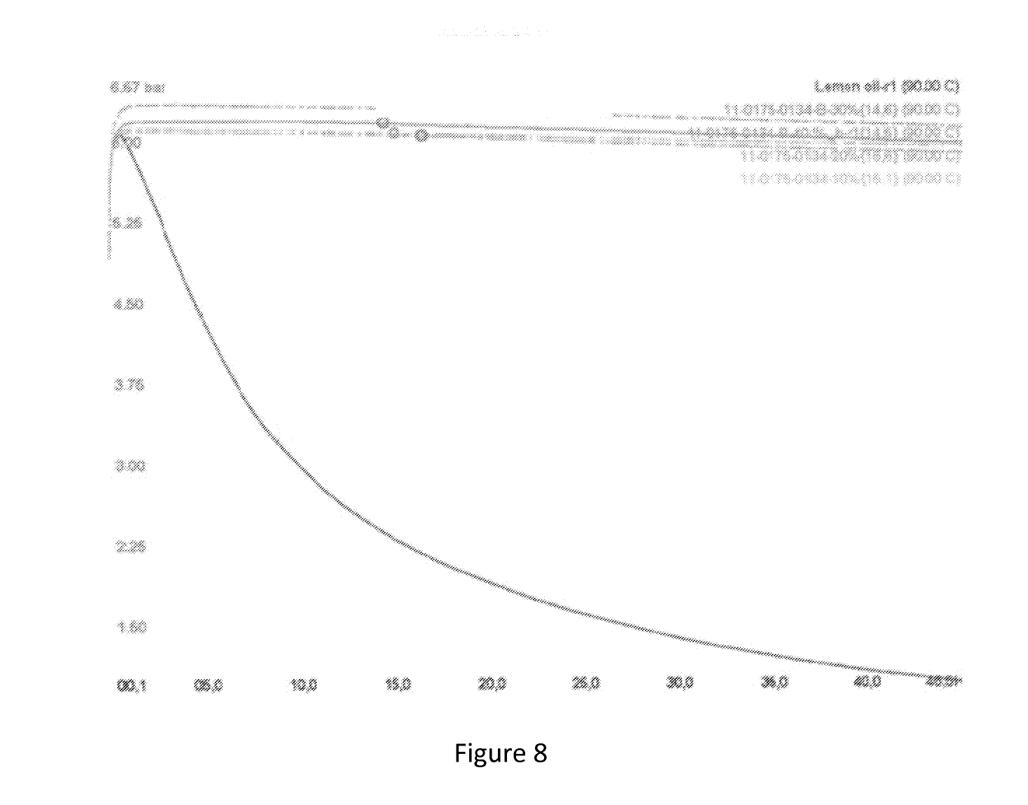

The capability of microencapsulated lemon oil samples from Example 3 as compared to lemon oil to withstand oxidation was evaluated using ML OXIPRES™ test method at elevated temperature and under an initial oxygen pressure of 5 bar. Samples of 10 grams for microencapsulated lemon oil were used for the test. A lemon oil sample of 5 g was used for the test for comparison. The results are shown in FIG. 8.

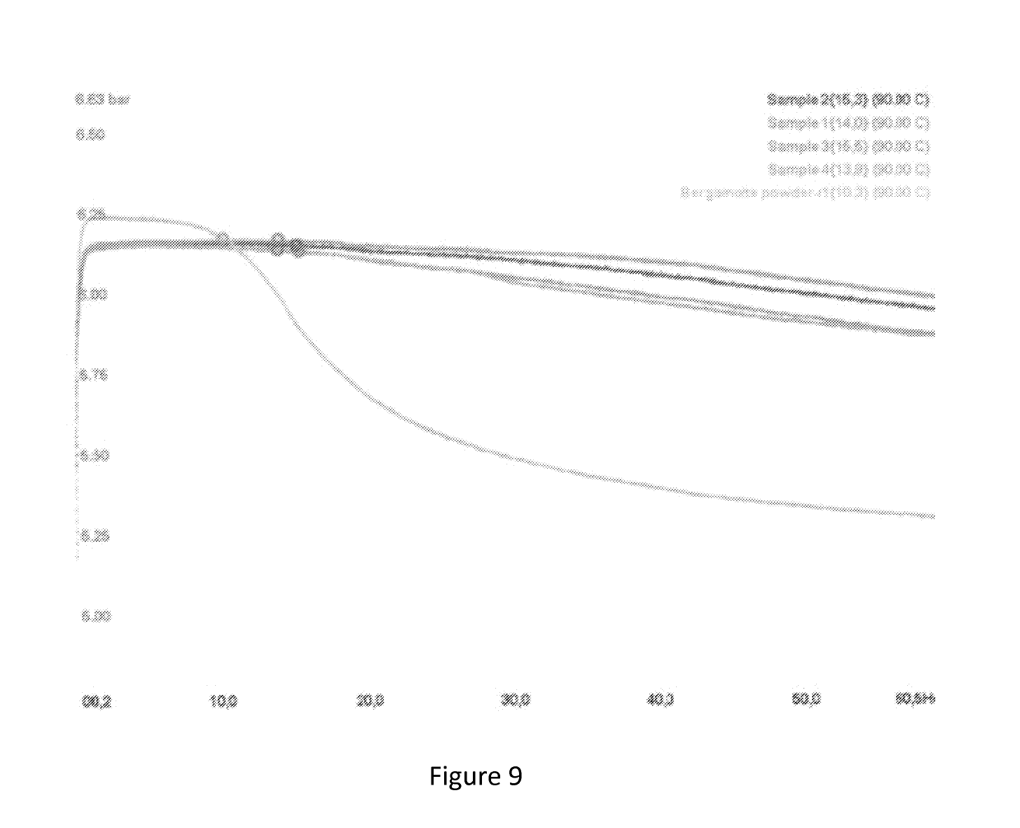

The capability of microencapsulated bergamot powder samples from Example 4 as compared to bergamot powder to withstand oxidation was evaluated using ML OXIPRES™ test method at elevated temperature and under an initial oxygen pressure of 5 bar. Samples of 10 grams for microencapsulated bergamot powder were used for the test. The results are shown in FIG. 9.

### Examples 6-10

### Using a Non-Emulsion Based Microencapsulation Preparation

### Descriptions

Forth beneath are examples of different kinds of flavouring agents which have been encapsulated according to the some embodiments of the present invention.

1. Lemon oil which is a highly volatile and oxygen sensitive flavouring agent. Its solubility in water is poor but freely soluble in both ethanol as well as isopropyl alcohol. Although such an oil is not highly lipophilic and viscous its high volatility makes the entrapment into the absorbent, in the absorption process, be difficult.

2. Non-volatile oil having high viscosity and sensitivity to oxygen. Although this oil is not volatile, its high viscosity and lipophility may make the absorption of the oil into the absorbent be difficult.

3. Spray dried lemon oil powder—This is a lemon oil which has been entrapped in a polymeric matrix, usually starch, using a spray dry method in order to reverse the liquid into solid particles. Generally from an industrial point of view, it is much more simple and less costly to transport, store, and handle powders than liquid food products. Such an entrapped lemon oil, however, is not totally protected against oxidation. Furthermore, the resulting powder from spray-dry method has highly fine particles and thus large surface area. This causes the powder to stick and have very poor flowability which may further make the handling very difficult. In microencapsulation point of view, since such a powder is very sticky, the fluidizing process is also not expected to be easy.

In all cases mentioned above the microencapsulation should be deigned as readily water soluble formulation which does not significantly hinder the release of flavouring agent into the oral cavity. The microencapsulation will be still able to provide the flavouring agent with a high protection against oxidation process.

### Example 6

### Microencapsulation of Lemon Oil (a Volatile Oil) Using Direct Spray

Sorbitol (300 g) which was used as water soluble absorbent was first loaded into a Ventilus Innojet-IEV2.5 V2. Lemon oil 145 g as is was then sprayed onto sorbitol using nitrogen as an inert gas. The inlet temperature was continuously kept at room temperature.

The process finished, yielding 425 g solidified lemon oil particles (lemon oil absorbed-sorbitol).

300 g of lemon oil absorbed-sorbitol was then loaded into an Innojet coater and polyethylene glycol 4000 (PEG 4000) (60 g) which was previously melted was sprayed using nitrogen as an inert gas. The coating was carried out at room temperature.

Then 270 g of PEG coated particles reloaded into Innojet-IEV2.5 V2 and an aqueous solution of Na-carboxymethyl cellulose (CMC 7L2P) (4%) and polyethylene glycol 400 (PEG 400) (1%), (20.25 g CMC and 6.75 g PEG in 513 g H2O) was sprayed onto above resulting PEG coated particles to reach weight gain of 10% of Na-carboxymethyl cellulose. Samples were taken after reaching 10% weight gain for both taste and accelerated oxidation stability tests.

The final product was dried and kept in a double sealed polyethylene bag with a proper desiccant in a refrigerator.

### Example 7

### Microencapsulation of Lemon Oil (a Volatile Oil) Using an Organic Solvent

Sorbitol (300 g) which was used as water soluble absorbent was first loaded into a Ventilus Innojet-IEV2.5 V2. Then a lemon oil (145.5 g) solution (total 291 g) in isopropyl alcohol (IPA) was sprayed onto sorbitol using nitrogen as an inert gas. The inlet temperature was continuously kept at room temperature.

The process finished, yielding 430 g solidified lemon oil particles (lemon oil absorbed-sorbitol).

330 g of lemon oil absorbed-sorbitol was then loaded into an Innojet coater and polyethylene glycol 4000 (PEG 4000) (66 g), previously melted, was sprayed using nitrogen as an inert gas. The coating was carried out at room temperature.

Then 300 g of PEG coated particles reloaded into Innojet-IEV2.5 V2 and an aqueous solution of Na-carboxymethyl cellulose (CMC 7L2P) (4%) and polyethylene glycol 400 (PEG 400) (1%), (22.5 g CMC and 7.5 g PEG in 570 g H2O) was sprayed onto above resulting PEG coated particles to reach weight gain of 10% of Na-carboxymethyl cellulose. Samples were taken after reaching 10% weight gain for both taste and accelerated oxidation stability tests.

The final product was dried and kept in a double sealed polyethylene bag with a proper desiccant in a refrigerator.

### Example 8

### Microencapsulation of a Non-Volatile Oil Using an Impregnation Method

Sorbitol (225 g) which was used as water soluble absorbent was first loaded into a rounded bottom pot. The non-volatile oil 145 gas is then added onto sorbitol by dropping using a separating funnel while mixing to form a homogenous and uniform mixing. Silicon dioxide (Aerosil) (3 g) was then added to ease the mixing and further increase the uniformity of the mixture. The impregnation was carried out at room temperature. The process finished, yielding 373 g solidified non-volatile oil particles (non-volatile oil absorbed-sorbitol).

373 g of non-volatile oil absorbed-sorbitol was then loaded into an Innojet coater and Poloxamer 188 (Lutrol F68) (75 g), previously melted, was sprayed using nitrogen as an inert gas. The coating was carried out at room temperature.

Then 300 g of Poloxamer coated particles reloaded into Innojet-IEV2.5 V2 and an aqueous solution of Na-carboxymethyl cellulose (CMC 7L2P) (4%) and polyethylene glycol 400 (PEG 400) (1%), (22.5 g CMC and 7.5 g PEG in 570 g H2O) was sprayed onto above resulting Poloxamer coated particles to reach weight gain of 10% of Na-carboxymethyl cellulose. Samples were taken after reaching 10% weight gain for both taste and accelerated oxidation stability tests.

The final product was dried and kept in a double sealed polyethylene bag with a proper desiccant in a refrigerator.

### Example 9

### Microencapsulation of a Non-Volatile Oil Using Direct Spray

Sorbitol (300 g) which was used as water soluble absorbent was first loaded into a Ventilus Innojet-IEV2.5 V2. Non-volatile oil 120 g as is was then sprayed onto sorbitol using nitrogen as an inert gas while spraying with a very low spray rate. The inlet temperature was continuously kept at room temperature. Different portions of silicon dioxide (Aerosil) (in total 3 g) was then added to ease the fluidizing and further increase the uniformity of the mixture.

The process finished, yielding 415 g solidified non-volatile oil particles (non-volatile oil absorbed-sorbitol).

370 g of non-volatile oil absorbed-sorbitol was then loaded into an Innojet coater and Poloxamer 188 (Lutrol F68) (75 g), previously melted, was sprayed using nitrogen as an inert gas. The coating was carried out at room temperature.

Then 300 g of Poloxamer coated particles reloaded into Innojet-IEV2.5 V2 and an aqueous solution of Na-carboxymethyl cellulose (CMC 7L2P) (4%) and polyethylene glycol 400 (PEG 400) (1%), (22.5 g CMC and 7.5 g PEG in 570 g H2O) was sprayed onto above resulting Poloxamer coated particles to reach weight gain of 10% of Na-carboxymethyl cellulose. Samples were taken after reaching 10% weight gain for both taste and accelerated oxidation stability tests.

The final product was dried and kept in a double sealed polyethylene bag with a proper desiccant in a refrigerator.

### Example 10

### Microencapsulation of Spray Dried Lemon Oil Powder

300 g of spray dried lemon oil powder and 3 g silicon dioxide (Aerosil) were loaded into a Ventilus Innojet-IEV2.5 V2 coater and mixed for about 2 minutes. Previously melted PEG 4000 (60 g), was then sprayed using nitrogen as an inert gas. The coating was carried out at room temperature.

Then 300 g of PEG 4000 coated particles reloaded into Innojet-IEV2.5 V2 and an aqueous solution of Na-carboxymethyl cellulose (CMC 7L2P) (4%) and polyethylene glycol 400 (PEG 400) (1%), (22.5 g CMC and 7.5 g PEG in 570 g H2O) was sprayed onto above resulting PEG coated particles to reach weight gain of 10% of Na-carboxymethyl cellulose. Samples were taken after reaching 10% weight gain for both taste and accelerated oxidation stability tests.

The final product was dried and kept in a double sealed polyethylene bag with a proper desiccant in a refrigerator

### Results

### 1. Taste Test Results

The samples from above experiments were tested by tasting in the mouth in order to find out whether or not the encapsulated flavouring agent according to the above formulations is immediately released. Taste tests showed that in all samples from the experiments mentioned above the onset of the flavouring agents release was within less than 40 seconds mainly 30 seconds. This finding shows clearly that microencapsulation formulations designed according to the present invention are totally water soluble and do not hinder the release of the flavouring agents form microencapsules.

### 2. Appearance and Flowability

All samples were particles in off-white colours. The samples were totally with superior flowability. It is noteworthy that the spray dried lemon oil powder which suffers from poor flowability, upon the microencapsulation process turned into free flowing particles with superior flowablilty.

### 3. Accelerated Oxidation Test

The capability of microencapsulated lemon oil samples from Example 6 and 7 as compared to lemon oil and spray dried lemon oil powder (non-encapsulated) to withstand oxidation was evaluated using ML OXIPRES™ test method at 90° C. and under oxygen pressure. Samples of 10 grams for each pattern were used for the test. For lemon oil sample of 5 g was used for the test. The results, shown by Induction Period, are summarized in Table 2 and demonstrated in FIG. 8 (lemon oil as is).

TABLE 2
Induction Periods (ML OXIPRESTM test method at 90°
C.) of different samples prepared according to an exemplary
embodiment of SOCAPS (Examples 6 and 7) as compared to
lemon oil as-is and spray dried lemon oil powder as-is

| | Test | Induction |
|---|---|---|
| | Temperature | Period |
| Sample | (° C.) | (Hours) |
| Microencapsulated lemon oil Example 6 | 90 | >240 |
| Microencapsulated lemon oil Example 7 | 90 | >240 |
| Lemon oil with absorbent | 90 | 5.6 |
| Lemon oil with absorbent + PEG 4000 from | 90 | 11.4 |
| Example 6 | | |
| Lemon oil with absorbent + PEG 4000 from | 90 | 9.6 |
| Example 7 | | |
| Spray dried lemon oil powder | 90 | 2.8 |
| (non-encapsulated) | | |
| Lemon oil as-is- test 1 | 90 | 0.17 |
| Lemon oil as-is- test 2 | 90 | 0.17 |

Some non-limiting examples of flavoring and/or like agents that may be applicable to this disclosure are provided below.

### Flavor Compounds

According to some demonstrative embodiments, the flavoring agents may include but not limited to, natural flavoring substances, for example, obtained from plant or animal raw materials, by physical, microbiological or enzymatic processes; nature-identical flavoring substances, e.g., obtained by synthesis or isolated through chemical processes, which are chemically and organoleptically identical to flavoring substances naturally present in products intended for human consumption; and/or artificial flavoring substances, including, for example, substances not identified in a natural product intended for human consumption, and which are typically produced by fractional distillation and/or additional chemical manipulation of naturally sourced chemicals, crude oil or coal tar (example flavor compounds are classed/grouped below):

Acids—Carboxylic acids have a pungent sour smell, such as is evident in many cheeses. This group includes common organic acids like acetic acid (the acidic flavor of vinegar) and less well known but equally recognizable compounds like propionic acid, which has a sour rancid smell, and is the dominant odor in Emmental cheese. The pungency of fatty acids disappears when they react with alcohols and become sweet fruity esters. For example, butyric acid (which accounts for the rancid smell of butter) when combined with an alcohol becomes the fruity aroma in pineapples and strawberries (ethyl butyrate), in apples and pineapples (methyl butyrate), in apricots (pentyl butyrate), or in cherries (geranyl butyrate).

Alcohols—Alcohols can form floral, fruity, or fermented flavors depending on their molecular weight and what other molecules they react with. Alcohols with lower molecular weight are soluble in water and are volatile and flavorful. Ethyl maltol, the flavor of caramelized sugar and cooked fruit, is an example. As their molecular weight increases, alcohols become oily and more subtle. Decanol, the flavor of orange blossoms, and menthol are large alcohols. Alcohol molecules generate different flavors when they react with other molecules. For example, benzyl alcohol is the aroma of jasmine and hyacinth, but when it reacts with an aldehyde it becomes benzaldehyde, which is almond flavor.

Aldehydes—Aldehydes are a varied group of flavor compounds that are similar to both acids and alcohols and therefore react easily with both. Aldehydes can be floral, fruity, grassy, nutty, toasted, coffee-like, or chocolaty. One of the most commonly used aldehydes is vanillin, the flavor of vanilla. Some, like ethyl cinnamaldehyde in cinnamon, or methyl salicylate (oil of wintergreen), are so pungent they tend to dominate other flavors in a plant.

Esters—Esters are a combination of two molecules—an alcohol and an acid. Acids give vegetables and fruits tartness, and they are part of the fatty acid structure of vegetable oils. Alcohols are mostly by-products of cell metabolism in plants. Fruits in particular contain enzymes that cause acids and alcohols to combine to form aromatic esters. Apple flavor is a combination of seven esters. But banana contains just a few strong-smelling esters that give it a less complex but stronger aromatic profile.

Ketones—Ketones are polar molecules that are highly soluble in water and form bonds easily with other molecules. The acetyl-based ketones are quite subtle, giving jasmine and basmati rice their floral fragrance. Others become more pronounced from browning, giving popping corn or toasting tortillas their pleasant aroma. Some ketones produce strong dairy aromas, from the sweet, tangy aroma of cottage cheese and sour cream to the more pungent notes of blue cheese.

Iones—This subgroup of ketones produces fruit and berry flavors.

Lactones—Lactones are cyclic esters with their acid component derived from lactic acid, one of the carboxylic acids in milk Lactones contribute to the flavors of cream, butter, honey, wine, and coconut. They are frequently added to margarine, shortening, and some baked goods to give them buttery flavors.

Phenols—Phenolic compounds account for many of the defining aromatic characteristics of spices and herbs. Eugenol, the flavor of clove, is in allspice, basil, bay leaf, cinnamon, clove, and galangal to varied degrees. Anethole is in anise, fennel, and star anise, and sotolon, a spicy caramel-tasting phenol, is in maple syrup, molasses, and tobacco. Capsaicin, the pungent part of chiles, is a phenol, as are the polyphenols in tannins.

Pyrazines—Pyrazines have the rich flavors of roasted nuts, chocolate, and browned meats. They bond easily with alcohols and acids and frequently are found in combination with them or with esters. In strong concentration they can taste musty, earthy, or fishy.

Sulfur compounds—Sulfur-containing compounds give alliums, cabbages, radishes, and mustard some of their pungency. When concentrated, sulfur compounds can be off-putting or can irritate membranes in the nose, eye, and mouth, but in small concentrations they provide an acid brightness. Much of the aromatics in roasted coffee beans come from mercaptans, which are sulfur compounds.

Terpenes—Terpenes are especially versatile, occurring in the volatile oils of many fruits and vegetables, most notably in herbs. They are volatile, which means they tend to play as top notes, providing an initial hit of light aroma, and then dissipate quickly. Most frequently terpenes have piney, woody, spicy, or citrus-like aromas. Some examples are caryophyllene, which is one of the spicy elements in allspice, black pepper, cinnamon, and clove; cineole, which gives a eucalyptus-like cooling effect to allspice, basil, bay leaf, cardamom, cubeb pepper, galangal, ginger, spearmint, and sage; citral, the citrus scent in coriander and lemongrass; and geraniol, the spicy floral quality in many tropical plants like galangal, lemongrass, and Szechwan pepper.

Smell Flavorants

Smell flavorants, or simply, flavorants, are engineered and composed in similar ways as with industrial fragrances and fine perfumes. Many flavorants consist of esters, which are often described as being “sweet” or “fruity”.

Essential Oil

An essential oil, which is also known as volatile oil or ethereal oil or aetherolea or simply as the “oil” of the plant from which is extracted, is a concentrated hydrophobic liquid containing volatile aroma compounds from plants. An oil is “essential” in the sense that it carries a distinctive scent, or essence, of the plant. Essential oils are used in food and drink as flavoring agents. Essential oils are generally extracted by distillation. Other processes include expression, or solvent extraction. Essential oils are derived from various sections of plants. Some plants, like the bitter orange, are sources of several types of essential oil. Examples of essential oil include by way of non-limiting example: allspice, juniper (both extracted from berries); almond, anise, buchu, celery, cumin and nutmeg oil (all extracted from seeds); cassia, cinnamon, sassafras (extracted from bark); cannabis, chamomile, clary sage, clove scented geranium, hops, hyssop, jasmine, lavender, manuka, marjoram orange, rose and ylang-ylang (extracted from flowers); basil, bay leaf, buchu, cinnamon, common sage, eucalyptus, lemon grass, melaleuca, oregano, patchouli, peppermint, pine, rosemary, spearmint, tea tree, thyme and wintergreen (extracted from leaves); bergamot, grapefruit, lemon, lime, orange and tangerine (extracted from peel); camphor, cedar, rosewood agarwood and sandalwood (extracted from wood); galangal and ginger (extracted from rhizome); frankincense and myrrh (extracted from resin) and valerian (extracted from root).

Aroma Compound

By definition an aroma compound, which is also known as odorant or aroma, is a chemical compound that has a smell or odor. Aroma compounds can either be synthetic or be found naturally in food such as wine, fruits and spices. Aroma compounds are also the main component of many fragrance oils, and essential oils and play a significant role in the production of flavorants, which are used in the food service industry to flavor, improve, and generally increase the appeal of their products. The following is an exemplary, non-limiting list of different kinds of aroma compounds classified according to their chemical structure:
Esters

| Compound name | Fragrance | Natural occurrence | Chcmical structure |
|---|---|---|---|
| Methyl formate | Ethereal | | 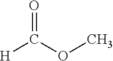 |
| Methyl acetate | Sweet, nail polish Solvent | | 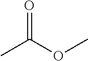 |
| Methyl butyrate Methyl butanoale | Fruity, Apple Pineapple | | 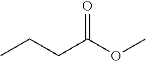 |
| Ethyl acetate | Sweet, solvent | Wine | 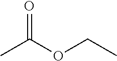 |
| Ethyl butyrate Ethyl butanoate | Fruity, Orange Pineapple | | 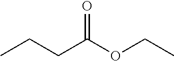 |
| Isoamyl acetate | Fruity, Banana Pear | Banana plant | 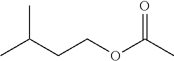 |
| Pentyl butyrate Pentyl butanoate | Fruity, Pear Apricot | | 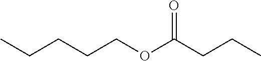 |
| Pentyl pentanoate | Fruity, Apple | | 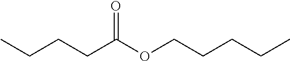 |
| Octyl acetate | Fruity, Orange | | 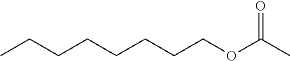 |

Linear terpenes

| Compound name | Fragrance | Natural occurrence | Chemical structure |
|---|---|---|---|
| Myrcene | Woody, complex | Verbena, Bay | 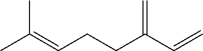 |
| Geraniol | Rose, flowery | Geranium, Lemon | 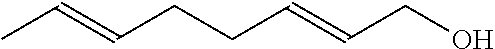 |
| Nerol | Sweet rose, flowery | Neroli, Lemongrass | 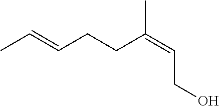 |
| Citral, lemonal Geranial, neral | Lemon | Lemon myrtle, Lemongrass | 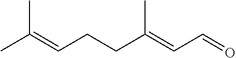 |
| Citronellal | Lemon | Lemongrass | 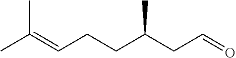 |
| Citronellol | Lemon | Lemongrass, rose Pelargonium | 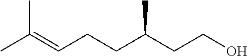 |
| Linalool | Floral, sweet Woody, Lavender | Coriander, Sweet basil Lavender | 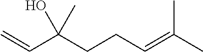 |
| Nerolidol | Woody, fresh bark | Neroli, ginger Jasmine | 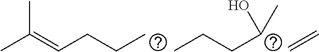 |

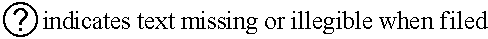

Cyclic terpenes

| Compound name | Fragrance | Natural occurrence | Chemical structure |
|---|---|---|---|
| Limonene | Orange | Orange, lemon | 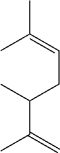 |
| Camphor | Camphor | Camphor laurel | 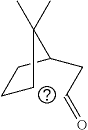 |
| Terpineol | Lilac | Lilac, Cajuput | 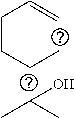 |
| alpha-Ionone | Violet, woody | Violet | 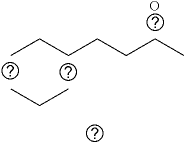 |
| Thujone | Minty | Cypress, lilac Juniper | 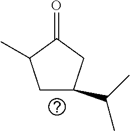 |

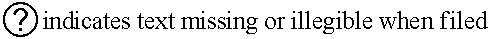

Aromatic

| Compound name | Fragrance | Natural occurrence | Chemical structure |
|---|---|---|---|
| Benzaldehyde | Almond | Bitter almond | 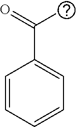 |
| Eugenol | Clove | Clove | 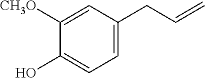 |
| Cinnamaldehyde | Cinnamon | Cassia Cinnamon | 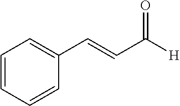 |
| Ethyl maltol | Cooked fruit Caramelized sugar | | 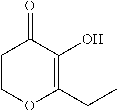 |
| Vanillin | Vanilla | Vanilla | 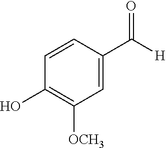 [SMILES: COc1cc(C=O)ccc1O] |
| Anisole | Anise | Anise | 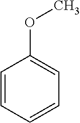 |
| Anethole | Anise | Anise Sweet basil | 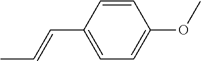 |
| Estragole | Tarragon | Tarragon | 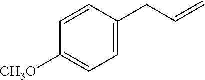 |
| Thymol | Thyme | Thyme | 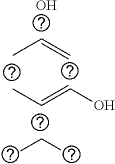 |

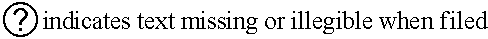

Amines

| Compound name | Fragrance | Natural occurrence | Chemical structure |
|---|---|---|---|
| Trimethylamine | Fishy Ammonia | | 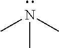 |
| Pyridine | Fishy | Belladonna | 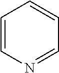 |
| Indole | Flowery | Jasmine | 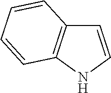 |

Fragrance oil(s), also known as aroma oils, aromatic oils, flavor oils, and/or the like are blended synthetic aroma compounds or natural essential oils that are diluted with a carrier like propylene glycol, vegetable oil, or mineral oil.

Examples of aromatic oils include but are not limited to ylang ylang, vanilla, sandalwood, cedar, mandarin, cinnamon, lemongrass, rosehip, peppermint, spearmint, and the like.

It is to be understood that where a range of values is provided in this disclosure, each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the disclosure, subject to any specifically excluded limit in the stated range. Where the stated range includes one or both of the limits, ranges excluding either or both of those included limits are also included in the disclosure. As used herein and in the appended claims, the singular forms “a”, “an”, and “the” may include plural referents unless the context clearly dictates otherwise.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1. A stabilized oxygen-sensitive flavoring agent particle for admixing to a food product comprising:
a core composition granule containing at least one oxygen-sensitive flavoring agent and at least one water soluble absorbent;
an inner coating layer whose aqueous solution of 0.1% has a surface tension lower than 60 mN/m measured at 25° C.; and
an outer coating layer comprising a polymer having an oxygen transmission rate of less than 1000 cc/m/24 hr measured at 23° C. and 0% RH, and a water vapor transmission rate of less than 400 g/m2/day.

2. The stabilized oxygen-sensitive flavoring agent particle of claim 1, further comprising a second outer coating layer.

3. The stabilized oxygen-sensitive flavoring agent particle of claim 2, wherein the second outer coating layer has a water vapor transmission rate of less than 300 g/m2/day.

4. The stabilized oxygen-sensitive flavoring agent particle of claim 1, wherein said at least one water soluble absorbent is sorbitol.

5. The stabilized oxygen-sensitive flavoring agent particle of claim 1, wherein said inner coating layer comprises hydroxypropyl cellulose (HPC).

6. The stabilized oxygen-sensitive flavoring agent particle of claim 1, wherein said outer coating layer comprises carboxymethylcellulose (CMC).

7. A stabilized oxygen-sensitive flavoring agent particle for admixing to a food product comprising:
a core composition in a form of solid powder containing at least one oxygen-sensitive flavoring agent and at least one water soluble absorbent;
an inner coating layer, wherein an aqueous solution of 0.1% of the inner coating layer has a surface tension lower than 45 mN/m measured at 25° C.; and
an outer coating layer comprising a polymer having an oxygen transmission rate of less than 100 cc/m/24 hr measured at standard test conditions and a water vapor transmission rate of less than 400 g/m2/day.

8. The stabilized oxygen-sensitive flavoring agent particle of claim 7, further comprising:
a second outer coating layer providing protection against water/humidity penetration.

9. The stabilized oxygen-sensitive flavoring agent particle of claim 8, wherein the second outer coating layer has a water vapor transmission rate of less than 300 g/m2/day.

10. The stabilized oxygen-sensitive flavoring agent particle of claim 7, wherein said at least one water soluble absorbent is sorbitol.

11. The stabilized oxygen-sensitive flavoring agent particle of claim 7, wherein said inner coating layer comprises hydroxypropyl cellulose (HPC).

12. The stabilized oxygen-sensitive flavoring agent particle of claim 7, wherein said outer coating layer comprises carboxymethylcellulose (CMC).

13. The stabilized oxygen-sensitive flavoring agent particle of claim 7, further comprising a stabilizer.

14. The stabilized oxygen-sensitive flavoring agent particle of claim 13, wherein said stabilizer is L-cysteine base.

15. A method of producing a stabilized, multi-layered particle containing oxygen-sensitive flavoring agent, comprising:
preparing a suspension of oxygen-sensitive flavoring agents using at least one surfactant and at least one hydrophilic water soluble polymer;
spraying the resulting suspension onto at least one water soluble absorbent to obtain a core granule;
coating the core granule with an inner coating layer comprising at least one water soluble polymer whose aqueous solution of 0.1% of the inner coating layer has a surface tension lower than 45 mN/m measured at 25° C. for preventing penetration of water into said core granule and for adjusting surface tension, to obtain a water-sealed coated particle having an adjusted surface tension; and
coating said water-sealed coated particle having an adjusted surface tension with an outer coating layer that reduces transmission of oxygen and humidity into the core granule to obtain a multi-layered particle containing oxygen-sensitive flavoring agent.

16. The method of claim 15, further comprising:
coating said multi-layered particle containing oxygen-sensitive flavoring agent with a second outer coating layer comprising a polymer having a water vapor transmission rate of less than 400 g/m2/day and providing further protection against water/humidity penetration.

17. The method of claim 15, further comprising:
coating said multi-layered particle containing oxygen-sensitive flavoring agent with a second outer coating layer comprising a polymer having a water vapor transmission rate of less than 350 g/m2/day and providing further protection against water/humidity penetration.

18. The method of claim 15, further comprising:
coating said multi-layered particle containing oxygen-sensitive flavoring agent with a second outer coating layer comprising a polymer having a water vapor transmission rate of less than 300 g/m2/day and providing further protection against water/humidity penetration.

19. The method of claim 15, wherein said spraying is done using an inert gas.

20. The method of claim 19, wherein said inert gas is nitrogen.
